(19) United States
(12) Patent Application Publication
(10) Pub. No.: US 2025/0234263 A1
(43) Pub. Date: Jul. 17, 2025

(54) RECOVERING FROM MOBILITY FAILURE

(71) Applicant: Samsung Electronics Co., Ltd., Suwon-si (KR)

(72) Inventor: Anil Agiwal, McKinney, TX (US)

(21) Appl. No.: 19/009,849

(22) Filed: Jan. 3, 2025

Related U.S. Application Data
(60) Provisional application No. 63/620,049, filed on Jan. 11, 2024.
(60) Provisional application No. 63/673,535, filed on Jul. 19, 2024.
(60) Provisional application No. 63/717,072, filed on Nov. 6, 2024.

(51) Int. Cl. H04W 36/30; H04W 36/00; H04W 36/08

(52) U.S. Cl. CPC H04W 36/305; H04W 36/0079; H04W 36/08

(57) ABSTRACT

A UE includes a transceiver. The transceiver is configured to receive, from a BS of a first cell, a LTM configuration of one or more LTM candidate cells, and receive, from the BS of the first cell, a command to switch to a second cell. The UE also includes a processor operatively coupled to the transceiver. The processor is configured to initiate a cell switch to the second cell, and detect a failure of the cell switch to the second cell. The processor is also configured to, upon detection of the failure, select, from the one or more LTM candidate cells, a third cell, and perform a procedure. The procedure includes initiating an LTM cell switch to the third cell, and configuring state variables in a PDCP entity of a SRB1 with values of the state variables in the PDCP entity from an earlier time.

### CROSS-REFERENCE TO RELATED APPLICATION(S) AND CLAIM OF PRIORITY

This application claims priority under 35 U.S.C. § 119 (e) to U.S. Provisional Patent Application No. 63/620,049 filed on Jan. 11, 2024, U.S. Provisional Patent Application No. 63/673,535 filed on Jul. 19, 2024, and U.S. Provisional Patent Application No. 63/717,072 filed on Nov. 6, 2024. The above-identified provisional patent applications are hereby incorporated by reference in their entirety.

### TECHNICAL FIELD

This disclosure relates generally to wireless networks. More specifically, this disclosure relates to recovering from mobility failure.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology [RAT]) to flexibly accommodate various services/applications with different requirements, new multiple access schemes to support massive connections, and so on.

### SUMMARY

This disclosure provides apparatuses and methods for recovering from mobility failure.

In one embodiment, a user equipment (UE) is provided. The UE includes a transceiver. The transceiver is configured to receive, from a base station (BS) of a first cell, a lower layer triggered mobility (LTM) configuration of one or more LTM candidate cells, and receive, from the BS of the first cell, a command to switch to a second cell. The UE also includes a processor operatively coupled to the transceiver. The processor is configured to initiate a cell switch to the second cell, and detect a failure of the cell switch to the second cell. The processor is also configured to, upon detection of the failure, select, from the one or more LTM candidate cells, a third cell, and perform a procedure. The procedure includes initiating an LTM cell switch to the third cell, and configuring state variables in a packet data convergence protocol (PDCP) entity of a signaling radio bearer 1 (SRB1) with values of the state variables in the PDCP entity from an earlier time.

In another embodiment, a method of operating a UE is proved. The method includes receiving, from a BS of a first cell, a lower layer triggered mobility (LTM) configuration of one or more LTM candidate cells, receiving, from the BS of the first cell, a command to switch to a second cell, initiating a cell switch to the second cell, and detecting a failure of the cell switch to the second cell. The method also includes, upon detection of the failure, selecting, from the one or more LTM candidate cells, a third cell, and performing a procedure. The procedure includes initiating an LTM cell switch to the third cell, and configuring state variables in a PDCP entity of a SRB1 with values of the state variables in the PDCP entity from an earlier time.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates example signaling procedures for inter-gNB handover according to embodiments of the present disclosure;

FIG. 5 illustrates an example procedure for LTM according to embodiments of the present disclosure;

FIGS. 6A-6B illustrate an example method of fast recovery to an LTM candidate cell upon LTM cell switch failure according to embodiments of the present disclosure;

FIGS. 7A-7B illustrate an example method of fast recovery to an LTM candidate cell upon mobility failure according to embodiments of the present disclosure; and

FIG. 8 illustrates an example method for recovering from mobility failure according to embodiments of the present disclosure.

### DETAILED DESCRIPTION

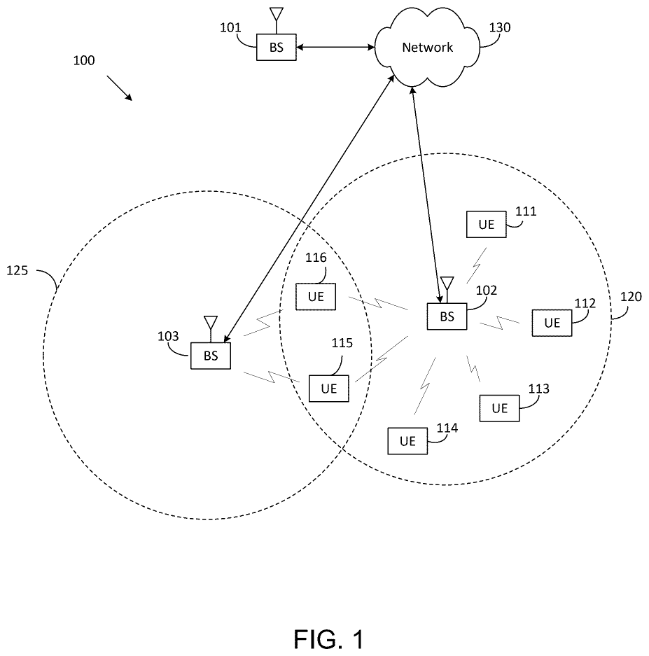

FIGS. 1 through 8, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mm Wave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for recovering from mobility failure. In certain embodiments, one or more of the gNBs 101-103 includes circuitry, programing, or a combination thereof, to support recovering from mobility failure in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

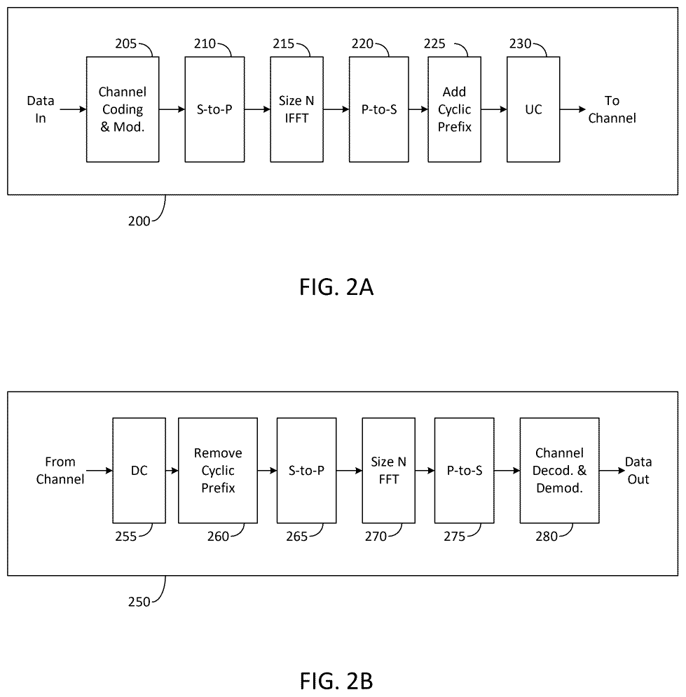

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support recovering from mobility failure as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols.

The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

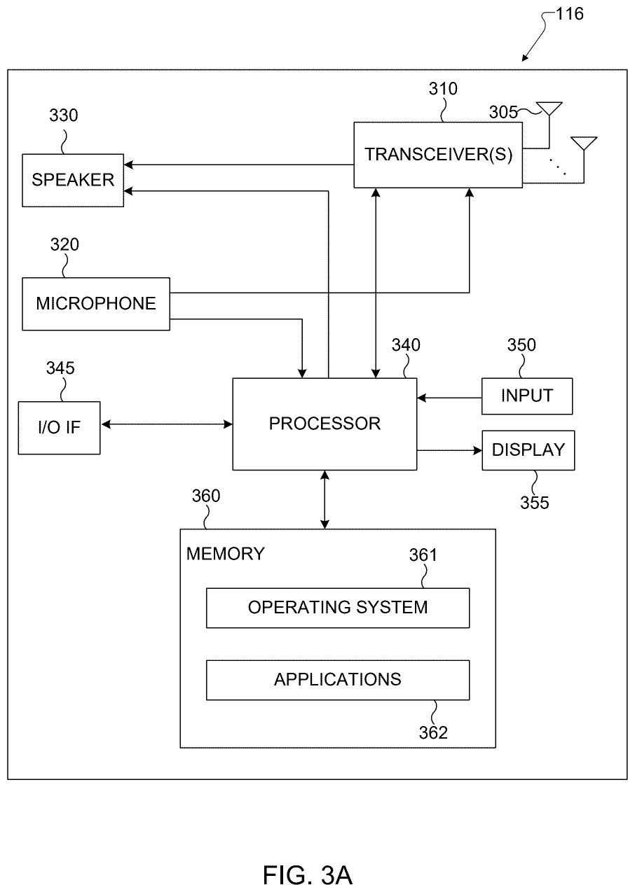

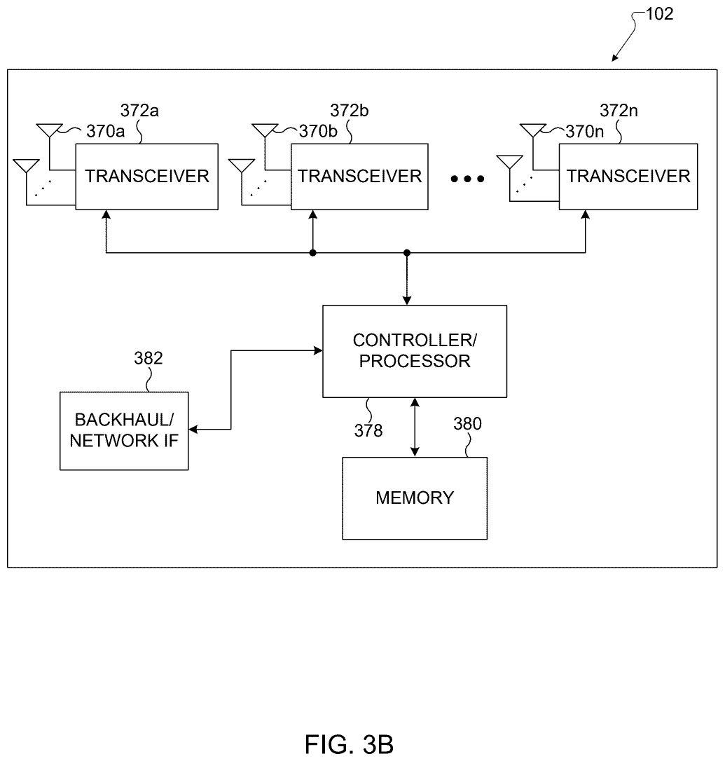

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for recovering from mobility failure as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support recovering from mobility failure as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

In the next generation wireless communication system (e.g., 5G, beyond 5G, 6G) operating in higher frequency (mmWave) bands, UEs and gNBs may communicate with each other using Beamforming. Beamforming techniques are used to mitigate propagation path losses and to increase propagation distance for communication at higher frequency bands. Beamforming enhances transmission and reception performance using a high-gain antenna. Beamforming can be classified into Transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing the propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can also be referred to as a transmit (TX) beam. Wireless communication systems operating at high frequency may use a plurality of narrow TX beams to transmit signals in the cell as each narrow TX beam provides coverage to a part of cell. The narrower the TX beam, the higher the antenna gain and hence a larger propagation distance of a signal transmitted using beamforming. A receiver can also generate plurality of receive (RX) beam patterns of different directions. Each of these receive patterns can be also referred to as a receive (RX) beam.

The next generation wireless communication system (e.g., 5G, beyond 5G, 6G) supports a standalone mode of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) and all secondary cells. In NR the term Master Cell Group (MCG) refers to a group of serving cells associated with the Master Node, comprising the Primary Cell (PCell) and optionally one or more secondary cells (SCells). In NR the term Secondary Cell Group (SCG) refers to a group of serving cells associated with the Secondary Node, comprising the Primary SCG Cell (PSCell) and optionally one or more SCells. In NR, PCell refers to a serving cell in the MCG, operating on the primary frequency, in which the UE either performs the initial connection establishment procedure or initiates the connection re-establishment procedure. In NR for a UE configured with CA, an SCell is a cell providing additional radio resources on top of a Special Cell. PSCell refers to a serving cell in the SCG in which the UE performs random access when performing the Reconfiguration with Sync procedure. For Dual Connectivity operation, Special Cell (SpCell) refers to the PCell of the MCG or the PSCell of the SCG. Otherwise, the term Special Cell refers to the PCell.

In the next generation wireless communication system (e.g., 5G, beyond 5G, 6G), a node B (gNB) or base station in cell broadcast Synchronization Signal and PBCH block (SSB) includes primary and secondary synchronization signals (PSS, SSS) and system information (SI). The SI includes common parameters needed to communicate in the cell. In the fifth generation wireless communication system (also referred as next generation radio or NR), SI is divided into the master information block (MIB) and a number of system information blocks (SIBs), wherein the MIB may be transmitted on the broadcast channel (BCH) with a periodicity of 80 ms and repetitions made within 80 ms and the MIB includes parameters that are needed to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI message, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with a same length for all SI messages). Each SI message is associated with an SI-window and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in SIB1. A cell specific SIB is applicable only within a cell that provides the SIB while an area specific SIB is applicable within an area referred to as an SI area, which includes one or several cells and is identified by systemInformationAreaID. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC_CONNECTED state, the network can provide system information through dedicated signaling using the RRCReconfiguration message, e.g., if the UE has an active BWP with no common search space configured to monitor system information, paging, or upon request from the UE. In an RRC_CONNECTED state, the UE acquires the required SIB(s) from the PCell. For the PSCell and SCells, the network provides the required SI by dedicated signaling, i.e., within an RRCReconfiguration message. Nevertheless, the UE shall acquire a MIB of the PSCell to get system frame number (SFN) timing of the SCG (which may be different from the MCG). Upon change of relevant SI for the SCell, the network releases and adds the concerned SCell. For the PSCell, the required SI can be changed with Reconfiguration with Sync.

In the next generation wireless communication system (e.g., 5G, beyond 5G, 6G), a Physical Downlink Control Channel (PDCCH) is used to schedule DL transmissions on a Physical Downlink Shared Channel (PDSCH) and UL transmissions on a Physical Uplink Shared Channel (PUSCH), where the Downlink Control Information (DCI) on the PDCCH includes: downlink assignments containing at least modulation and coding format, resource allocation, and hybrid-ARQ information related to DL-SCH; uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for the Physical Uplink Control Channel (PUCCH) and PUSCH; transmission of one or more TPC commands for SRS transmissions by one or more UEs; switching a UE's active bandwidth part (BWP); and initiating a random access procedure. A UE monitors a set of PDCCH candidates in the configured monitoring occasions in one or more configured COntrol REsource SETs (CORESETs) according to the corresponding search space configurations. A CORESET includes a set of PRBs with a time duration of 1 to 3 OFDM symbols. The resource units Resource Element Groups (REGs) and Control Channel Elements (CCEs) are defined within a CORESET with each CCE including a set of REGs. Control channels are formed by aggregation of CCEs. Different code rates for the control channels are realized by aggregating different numbers of CCEs. Interleaved and non-interleaved CCE-to-REG mappings are supported in a CORESET. Polar coding is used for the PDCCH. Each resource element group carrying the PDCCH carries its own DeModulation Reference Signal (DMRS). Quadrature Phase Shift Keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. The search space identifier is unique amongst the BWPs of a serving cell. An identifier of search space configuration to be used for specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines a PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below: (y*(number of slots in a radio frame)+x-Monitoring-offset-PDCCH-slot) mod (Monitoring-periodicity-PDCCH-slot)=0;

The starting symbol of a PDCCH monitoring occasion in each slot having PDCCH monitoring occasion is given by the parameter Monitoring-symbols-PDCCH-within-slot. The length (in symbols) of a PDCCH monitoring occasion is given in the CORESET associated with the search space. A search space configuration includes the identifier of CORESET configuration associated with it. A list of CORESET configurations are signaled by the gNB for each configured BWP of the serving cell, wherein each CORESET configuration is uniquely identified by a CORESET identifier. The CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SCS). The number of slots in a radio frame and duration of slots for each supported SCS is pre-defined in NR. Each CORESET configuration is associated with a list of TCI (Transmission configuration indicator) states. One DL RS ID (SSB or CSI RS) is configured per TCI state. The list of TCI states corresponding to a CORESET configuration is signaled by the gNB via RRC signaling. One of the TCI states in a TCI state list is activated and indicated to the UE by the gNB. The TCI state indicates the DL TX beam (DL TX beam is QCLed with an SSB/CSI RS of the TCI state) used by the gNB for transmission of the PDCCH in the PDCCH monitoring occasions of a search space.

In the next generation wireless communication system (e.g., 5G, beyond 5G, 6G) bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE only has to monitor PDCCH on the one active BWP i.e., it does not have to monitor the PDCCH on the entire DL frequency of the serving cell. In an RRC connected state, the UE is configured with one or more DL and UL BWPs, for each configured Serving Cell (i.e., PCell or SCell). For an activated Serving Cell, there is one active UL and DL BWP at any point in time. BWP switching for a Serving Cell is used to activate an inactive BWP and deactivate an active BWP at a time. BWP switching is controlled by the PDCCH indicating a downlink assignment or an uplink grant, by the bwp-Inactivity Timer, by RRC signalling, or by the MAC entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both UL and DL. Upon expiry of the BWP inactivity timer, the UE switches the active DL BWP to the default DL BWP or initial DL BWP (if a default DL BWP is not configured).

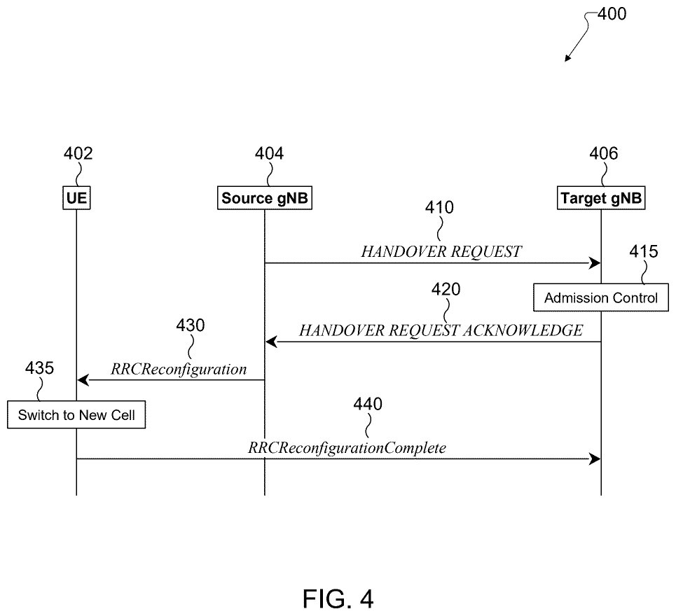

In the next generation wireless communication system (e.g., 5G, beyond 5G, 6G), there are two types of mobility: cell level mobility and beam level mobility. Cell Level Mobility utilizes explicit RRC signaling to be triggering (i.e., handover). For inter-gNB handover, the signaling procedures comprise at least the components shown in FIG. 4.

FIG. 4 illustrates example signaling procedures 400 for inter-gNB handover according to embodiments of the present disclosure. An embodiment of the signaling procedures illustrated in FIG. 4 are for illustration only. One or more of the components illustrated in FIG. 4 may be implemented in specialized circuitry configured to perform the noted functions or one or more of the components may be implemented by one or more processors executing instructions to perform the noted functions. Other embodiments of signaling procedures for inter-gNB handover could be used without departing from the scope of this disclosure.

In the example of FIG. 4, source gNB 404 initiates handover and issues a HANDOVER REQUEST 410 over an Xn interface to a target gNB 406. Target gNB performs admission control at step 415 and provides a new RRC configuration as part of a HANDOVER REQUEST ACKNOWLEDGE 420. Source gNB 404 provides the RRC configuration to UE 402 by forwarding the RRCReconfiguration message 430 received in the HANDOVER REQUEST ACKNOWLEDGE 420. The RRCReconfiguration message 430 includes at least cell ID and all information required to access the target cell so that the UE 402 can access the target cell without reading system information. For some cases, the information required for contention-based and contention-free random access can be included in RRCReconfiguration message 430. The access information to the target cell may include beam specific information, if any. At step 435, UE 402 moves the RRC connection to target gNB 406 and replies with the RRCReconfigurationComplete message 440. The example of FIG. 4 may be referred to as a network controlled or network initiated handover procedure.

Although FIG. 4 illustrates one example of signaling procedures 400 for inter-gNB handover, various changes may be made to FIG. 4. For example, while shown as a series of steps, various steps in FIG. 4 could overlap, occur in parallel, occur in a different order, occur any number of times, be omitted, or replaced by other steps.

In addition to network controlled/network initiated handover, the next generation wireless communication system (e.g., 5G, beyond 5G, 6G) also supports conditional handover and dual active protocol stack (DAPS) handover. In the case of conditional handover, the network can configure one or more candidate cells for conditional handover and one or more L3 measurement based events based on which UE decides to perform a conditional handover procedure. In the case of DAPS handover, the UE continues the downlink user data reception from the source gNB until releasing the source cell and continues the uplink user data transmission to the source gNB until a successful random access procedure to the target gNB.

Layer 1 (L1)/layer 2 (L2) triggered mobility, also referred to herein as lower layer triggered mobility (LTM), is a procedure in which a gNB receives L1 measurement report(s) from a UE, and on the basis of the L1 measurement report(s) the gNB changes the UE's serving cell by a cell switch command signaled via a MAC CE. The cell switch command indicates an LTM candidate cell configuration that the gNB previously prepared and provided to the UE through RRC signaling. Then the UE switches to the target cell according to the cell switch command. The LTM procedure can be used to reduce mobility latency. The network may request the UE to perform early TA acquisition of a candidate cell before a cell switch. The early TA acquisition is triggered by a PDCCH order or through a UE-based TA measurement.

The network indicates in the cell switch command whether the UE shall access the target cell with a random access (RA) procedure if a TA value is not provided or with a PUSCH transmission using the indicated TA value. For random access channel (RACH) less LTM, the UE accesses the target cell via the configured grant (CG) provided in the RRC signaling and selects the CG occasion associated with the beam indicated in the cell switch command. The UE may monitor the PDCCH for dynamic scheduling from the target cell upon an LTM cell switch.

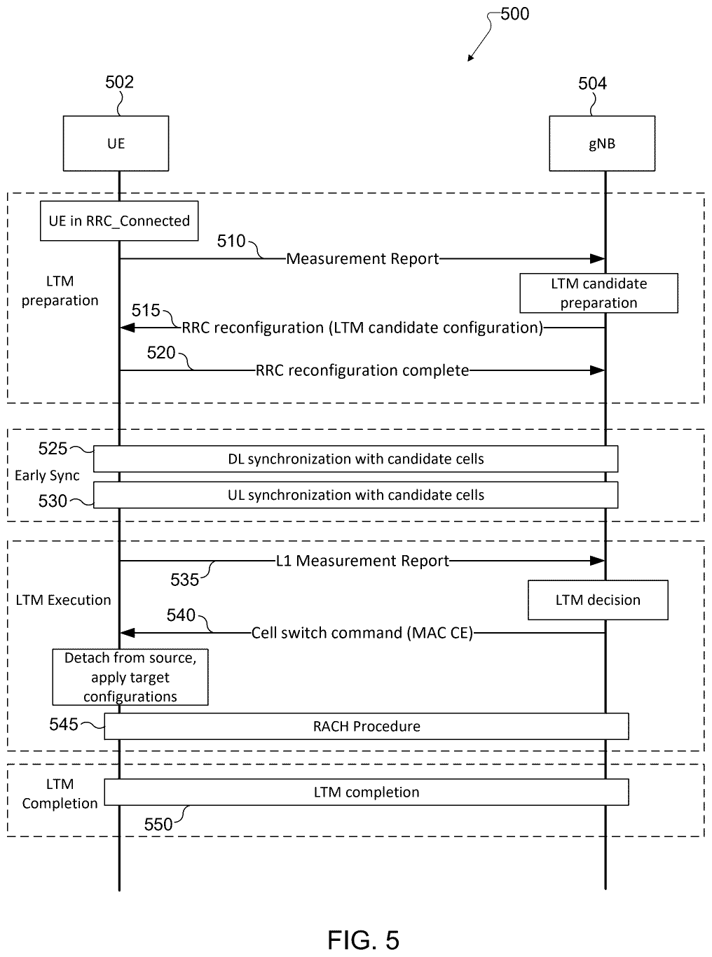

FIG. 5 illustrates an example procedure for LTM 500 according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure for LTM could be used without departing from the scope of this disclosure.

In the example of FIG. 5, procedure 500 begins at step 1. At step 510, UE 502, which is in an RRC connected state sends a MeasurementReport message to gNB 504. gNB 504 then decides to configure LTM and initiates candidate cell(s) preparation.

At step 515, gNB 504 transmits an RRCReconfiguration message to UE 502 including the LTM candidate cell configurations of one or multiple candidate cells.

At step 520, UE 502 stores the LTM candidate cell configurations and transmits an RRCReconfigurationComplete message to gNB 504.

At step 525, UE 502 may perform DL synchronization with candidate cell(s) before receiving a cell switch command.

At step 530, if requested by the network, UE 502 performs early TA acquisition with candidate cell(s) before receiving the cell switch command. This is done via contention free random access (CFRA) triggered by a PDCCH order from the source cell, following which UE 502 sends a preamble towards the indicated candidate cell. In order to minimize the data interruption of the source cell due to the CFRA towards the candidate cell(s), UE 502 doesn't receive a RAR for the purpose of TA value acquisition and the TA value of the candidate cell is indicated in the cell switch command. UE 502 doesn't maintain the TA timer for the candidate cell and relies on network implementation to guarantee the TA validity.

At step 535, UE 502 performs L1 measurements on the configured candidate cell(s) and transmits L1 measurement reports to the gNB.

At step 540, gNB 504 decides to execute cell switch to a target cell and transmits a MAC CE triggering cell switch by including the candidate configuration index of the target cell. UE 502 switches to the target cell and applies the configuration indicated by the candidate configuration index.

At step 545, UE 502 performs a random access procedure towards the target cell if UE does not have valid TA of the target cell.

At step 550, UE 502 completes the LTM cell switch procedure by sending a RRCReconfigurationComplete message to the target cell. If UE 502 has performed a RA procedure in step 7, UE 502 considers that the LTM execution is successfully completed when the random access procedure is successfully completed. For RACH-less LTM, UE 502 considers that the LTM execution is successfully completed when the UE determines that the network has successfully received its first UL data. UE 502 determines successful reception of its first UL data by receiving a PDCCH addressing UE 502's C-RNTI in the target cell, which schedules a new transmission following the first UL data.

For LTM, the network may indicate one or more L1 measurement based events based on which UE 502 may initiate LTM execution to a candidate LTM cell without receiving a cell switch command from gNB 504. This procedure may be referred as conditional LTM or UE initiated LTM. A list of one or more candidate LTM cells for conditional LTM or UE initiated LTM may be signaled by gNB 504 in an RRCReconfiguration message (step 515).

Although FIG. 5 illustrates one example procedure for LTM 500, various changes may be made to FIG. 5. For example, while shown as a series of steps, various steps in FIG. 5 could overlap, occur in parallel, occur in a different order, occur any number of times, be omitted, or replaced by other steps.

For LTM, the network may indicate one or more L1 measurement based events based on which a UE may initiate an LTM execution to a candidate LTM cell without receiving a cell switch command from a gNB. This procedure may be referred to as conditional LTM or UE initiated LTM. A list of one or more candidate LTM cells for a conditional LTM or UE initiated LTM may be signaled by the gNB in an RRCReconfiguration message (such as in step 515 of FIG. 5).

Upon an LTM cell switch failure (i.e., supervision timer/T304 expiry), fast recovery to LTM candidate cell is supported. The UE performs cell selection upon an LTM cell switch failure. If the selected cell is an LTM candidate cell, the UE performs a RACH-based LTM cell switch on the selected cell. If the selected cell is not an LTM candidate cell, the UE transmits an RRC re-establishment request.

Keystream reuse issue may occur during an LTM cell switch as follows:

Consider that a UE is configured with LTM candidate cells Cell B and Cell C. Then the UE receives a cell switch command to switch to Cell B. A PDCP COUNT value ‘N’ is used for transmitting RRCReconfigurationComplete to Cell B, and the PDCP COUNT value stored is then incremented to ‘N+1’. An LTM cell switch failure may occur after transmitting the RRCReconfigurationComplete massage. At a cell switch failure, the UE reverts back to the source configuration. The PDCP COUNT value is reverted. This means the PDCP COUNT value stored becomes ‘N’ again. Then the UE performs an RRC re-establishment procedure. If the selected cell is the candidate Cell C, the UE initiates an LTM to Cell C and the UE transmits a RRCReconfigurationComplete massage with the same COUNT value ‘N’. This results in keystream reuse (i.e., same security key and counter) for messages with different contents. This should be avoided for secured transmission as using the same security key and counter for messages with different contents will result in an attacker knowing the security key used for transmission. Various embodiments of the present disclosure provide methods to avoid keystream reuse for messages with different contents.

An LTM configuration may include candidate cells belonging to the same and/or different CUs/gNBs. In case an LTM cell switch is performed towards the selected cell during the RRC re-establishment procedure, the UE does not know how to determine the security key(s) for the selected cell. One solution would be to not revert PDCP state variables upon LTM switching failure. However, this is not efficient, as the candidate cell selected during recovery may not be an LTM candidate cell. Also, this does not solve the key stream reuse case of handover failure followed by LTM cell switch during recovery. Various embodiments of the present disclosure provide methods for a UE to determine the security key(s) for the selected cell during an LTM cell switch.

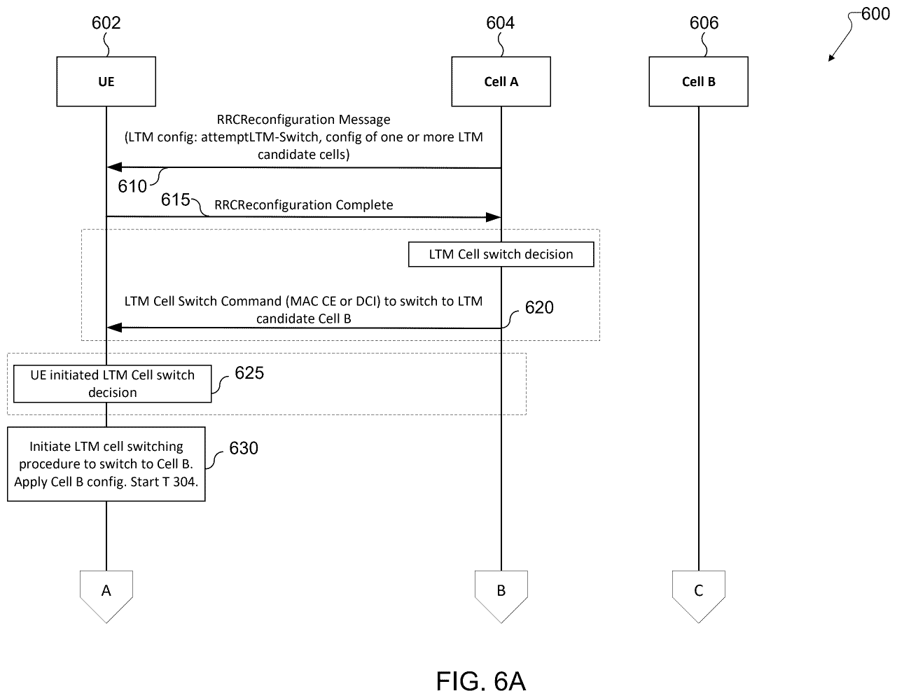

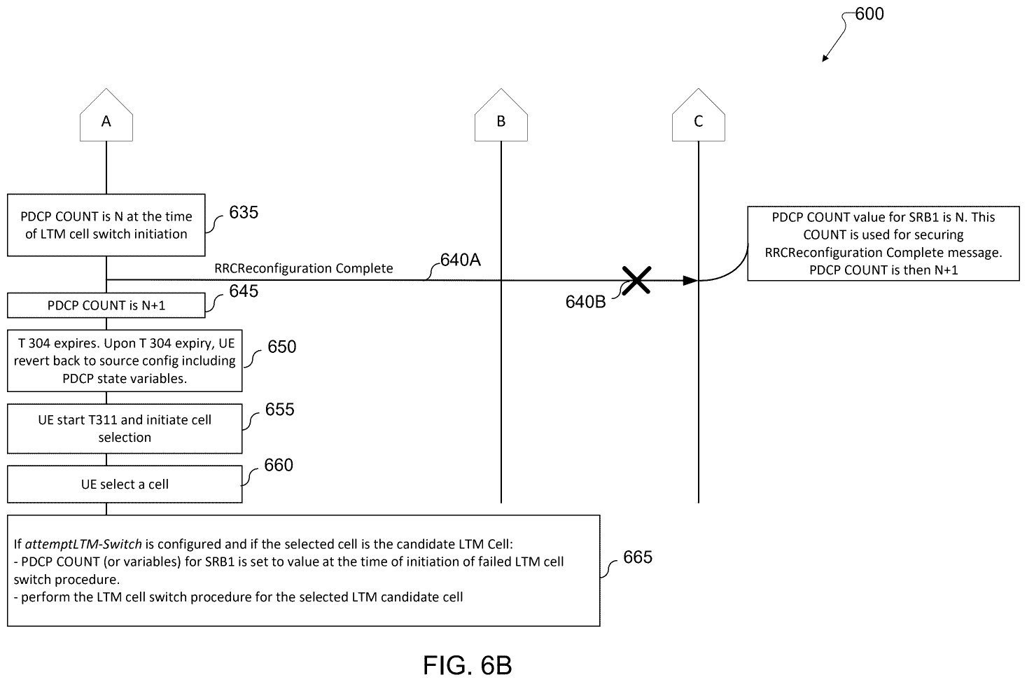

FIGS. 6A-6B illustrate an example method of fast recovery to an LTM candidate cell upon LTM cell switch failure 600 according to embodiments of the present disclosure. An embodiment of the method illustrated in FIGS. 6A-6B is for illustration only. One or more of the components illustrated in FIGS. 6A-6B may be implemented in specialized circuitry configured to perform the noted functions or one or more of the components may be implemented by one or more processors executing instructions to perform the noted functions. Other embodiments of a method of fast recovery to an LTM candidate cell upon LTM cell switch failure could be used without departing from the scope of this disclosure.

In the example of FIGS. 6A-6B, method 600 begins at step 610. At step 610, UE 602 receives an RRCReconfiguration message from gNB 604 of the serving cell (e.g., Cell A). The received RRCReconfiguration message includes an LTM configuration. The LTM configuration may include a configuration of one or more LTM candidate cells (e.g., Cell B, Cell C etc.). The configuration of each LTM candidate cell can be a RRCReconfiguration IE. the LTM configuration may include parameter attemptLTM-Switch or attemptLTM-Switch set to TRUE. If attemptLTM-Switch is present, the UE executes an LTM cell switch if the selected cell during connection re-establishment is an LTM candidate cell, and the selected cell is the first cell selection after failure.

At step 615, UE 602 sends an RRCReconfiguration complete message to the serving cell in response to the received RRCReconfiguration message.

At step 620, UE 602 may then receive an LTM cell switch command (MAC CE or DCI) to switch to an LTM candidate cell (e.g., Cell B) or at step 625 UE 602 may itself decide to switch to an LTM candidate cell (e.g., Cell B) (e.g., if certain conditions/events/criteria configured for UE initiated LTM cell switch are met).

At step 630, UE 602 initiates an LTM cell switching procedure to switch to LTM candidate Cell B. UE 602 applies the Cell B configuration received in the LTM configuration. UE 602 starts a supervision timer e.g., T 304. This timer is stopped upon successful switching to Cell B.

During switching, at step 640A, UE 602 generates an RRCReconfiguration complete message and transmits it to LTM candidate Cell B (e.g., gNB 606). The RRCReconfiguration complete message generated by the RRC layer is secured in the PDCP layer before transmission. The PDCP COUNT (PDCP TX COUNT) value for SRB1 is N at the time of the LTM cell switch initiation (step 635). This PDCP COUNT (PDCP TX COUNT) together with a security key is used for securing the RRCReconfiguration Complete message. At step 645, the PDCP COUNT (PDCP TX COUNT) for SRB1 is then incremented by 1 and becomes equal to N+1.

The RRCReconfiguration complete message may be transmitted in PUSCH resource. For example, in some embodiments the PUSCH resource/UL grant could be Msg3 (i.e., an UL grant received in a RAR if a random access procedure was initiated upon switching initiation) PUSCH resource/UL grant. In some embodiments, the PUSCH resource/UL grant could be MsgA (i.e., if a random access procedure was initiated upon switching initiation). In some embodiments, the PUSCH resource/UL grant could be configured grant received in an LTM configuration of candidate cell B for a RACH less cell switch.

If the UE has performed a RA procedure upon switching initiation, the UE considers that LTM execution is successfully completed when the random access procedure is successfully completed. For RACH-less LTM, the UE considers that LTM execution is successfully completed when the UE determines that the network has successfully received its first UL data. The UE determines successful reception of its first UL data by receiving a PDCCH addressing the UE's C-RNTI in the target cell, which schedules a new transmission following the first UL data.

At step 640A, the transmission of the RRCReconfiguration complete message may fail (step 640B) and at step 650, T 304 may expire. Expiry of T 304 means that LTM switching to LTM candidate cell B has failed.

Upon LTM cell switch failure (also referred to as reconfiguration with sync failure towards the LTM candidate cell of the MCG (or SCG)):

At step 650, UE 602 reverts back to the source (i.e. Cell A) configuration including the PDCP state variables.

At step 655, UE 602 initiates an RRC connection re-establishment, starts timer T311, and initiates cell selection.

At step 660, UE 602 selects a cell while T 311 is running.

In some embodiments, at step 665, if attemptLTM-Switch is configured (in the received LTM configuration) and if the selected cell is the candidate LTM Cell (in the received LTM configuration, which can be candidate LTM Cell B or any other candidate LTM cell e.g., Cell C):

PDCP COUNT/PDCP_TX_COUNT (and/or other PDCP state variables) for SRB1 are set to the same value(s) at the time of the LTM cell switch procedure failure (e.g., at the time of T 304 expiry), and UE 602 configures the PDCP entity of the SRB1 with state variables continuation (i.e., UE 602 continues with the same value[s] as at the time of the LTM cell switch procedure failure). Alternately, PDCP COUNT/PDCP_TX_COUNT (and/or other PDCP state variables) for SRB3 are set to the same value(s) at the time of the LTM cell switch procedure failure (e.g., at the time of T 304 expiry for the SCG), and UE 602 configures the PDCP entity of the SRB3 with state variables continuation (i.e., UE 602 continues the with same value[s] as at the time of the LTM cell switch procedure failure in the SCG). Alternately, PDCP COUNT/PDCP_TX_COUNT (and/or other PDCP state variables) for SRB(s)/RB(s) are set to the same value(s) at the time of the LTM cell switch procedure failure (e.g., at the time of T 304 expiry), and UE 602 configures the PDCP entities of the SRB(s)/RB(s) with state variables continuation (i.e., UE 602 continues with same value[s] as at the time LTM cell switch procedure failure).

UE 602 performs the LTM cell switch procedure for the selected LTM candidate cell. An RRCReconfiguration complete message is transmitted to the selected LTM candidate cell. PDCP COUNT/PDCP_TX_COUNT equal to N+1 will be used to secure the RRCReconfiguration complete message transmitted to the selected LTM candidate cell.

If the selected cell and the cell where cell switch failure occurred belong to a different group (i.e., a different CU or group of cells with a different security key or a group of cells with a different master key update ID or ID, the master key update ID or ID can be signaled per LTM candidate cell, cells belonging to same CU are assigned same value of master key update ID or ID, cells belonging to different CUs are assigned different value of master key update ID or ID):

In some embodiments, UE 602 may derive a new key K_{gNB} (also referred to as K_{gNB}*) for the target cell (i.e., the selected LTM candidate cell) using horizontal key derivation (i.e., K_{gNB}* is derived from the currently active K_{gNB} [i.e., K_{gNB} used in source cell]). Finally, K_{RRCint}, K_{RRCene}, K_{UPint} and K_{UPenc} are derived from new K_{gNB}. RRCReconfiguration complete message transmitted to selected LTM candidate cell is encrypted/integrity protected using K_{RRCenc}/K_{RRCint} keys.

In some embodiments, UE 602 may derive new key K_{gNB} (also referred as K_{gNB}*) for the target cell (i.e., selected LTM candidate cell) using vertical key derivation (i.e., K_{gNB}* is derived from the next hop parameter [NH]). Finally, keys K_{RRCint}, K_{RRCenc}, K_{UPint} and K_{UPenc} are derived from new K_{gNB}. The RRCReconfiguration complete message transmitted to selected LTM candidate cell is encrypted/integrity protected using K_{RRCenc}/K_{RRCint} keys.

In some embodiments, a next hop chaining counter parameter (NCC) used during failure recovery can be signaled by gNB 604 in the LTM configuration. If this NCC is the same as the NCC associated with the currently active K_{gNB}. UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., K_{gNB} used in source cell]). Otherwise, UE 602 derives a new key K_{gNB} (also referred to as K_{gNB}*) for the target cell (i.e., the selected LTM candidate) cell using vertical key derivation (i.e., K_{gNB}* is derived from the NH). Finally, keys K_{RRCint}, K_{RRCenc}, K_{UPint} and K_{UPenc} are derived from the new K_{gNB}. A RRCReconfiguration complete message transmitted to the selected LTM candidate cell is encrypted/integrity protected using the K_{RRCenc}/K_{RRCint} keys.

In some embodiments, whether to use vertical or horizontal key derivation during failure recovery can be signaled by gNB 604 in the LTM configuration. If horizontal key derivation is indicated UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., K_{gNB} used in source cell]). Otherwise, if vertical key derivation is indicated, UE 602 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. An RRCReconfiguration complete message transmitted to the selected LTM candidate cell is encrypted/integrity protected using the K_{RRCenc}/K_{RRCint} keys.

In some embodiments, at step 665, if attemptLTM-Switch is configured (in the received LTM configuration) and if the selected cell is the candidate LTM Cell (in the received LTM configuration) and this selected cell is not the cell where the LTM switching failed (i.e., the selected cell is a cell other than cell B):

PDCP COUNT/PDCP_TX_COUNT (and/or other PDCP state variables) for SRB1 are set to the same value(s) at the time of the LTM cell switch procedure failure (e.g., at the time of T 304 expiry), and UE 602 configures the PDCP entity of the SRB1 with state variables continuation (i.e., UE 602 continues with the same value[s] as at the time of the LTM cell switch procedure failure). Alternately, PDCP COUNT/PDCP_TX_COUNT (and/or other PDCP state variables) for SRB3 are set to the same value(s) at the time of the LTM cell switch procedure failure (e.g., at the time of T 304 expiry for the SCG), and UE 602 configures the PDCP entity of the SRB3 with state variables continuation (i.e., UE 602 continues the with same value[s] as at the time of the LTM cell switch procedure failure in the SCG). Alternately, PDCP COUNT/PDCP_TX_COUNT (and/or other PDCP state variables) for SRB(s)/RB(s) are set to the same value(s) at the time of the LTM cell switch procedure failure (e.g., at the time of T 304 expiry), and UE 602 configures the PDCP entities of the SRB(s)/RB(s) with state variables continuation (i.e., UE 602 continues with same value[s] as at the time LTM cell switch procedure failure).

UE 602 performs the LTM cell switch procedure for the selected LTM candidate cell. An RRCReconfiguration complete message is transmitted to the selected LTM candidate cell. PDCP COUNT/PDCP_TX_COUNT equal to N+1 will be used to secure the RRCReconfiguration complete message transmitted to the selected LTM candidate cell.

If the selected cell and cell where cell switch failure occurred belong to a different group (i.e., a different CU or group of cells with a different security key or a group of cells with a different master key update ID or ID, the master key update ID or ID can be signaled per LTM candidate cell, cells belonging to same CU are assigned same value of master key update ID or ID, cells belonging to different CUs are assigned different value of master key update ID or ID):

In some embodiments, UE 602 may derive a new key K_{gNB} (also referred to as K_{gNB}*) for the target cell (i.e., the selected LTM candidate cell) using horizontal key derivation (i.e., K_{gNB}* is derived from the currently active K_{gNB} [i.e., K_{gNB} used in source cell]). Finally, K_{RRCint}, K_{RRCenc}, K_{UPint} and K_{UPenc} are derived from new K_{gNB}. RRCReconfiguration complete message transmitted to selected LTM candidate cell is encrypted/integrity protected using K_{RRCenc}/K_{RRCint} keys.

In some embodiments, UE 602 may derive new key K_{gNB} (also referred as K_{gNB}*) for the target cell (i.e., selected LTM candidate cell) using vertical key derivation (i.e., K_{gNB}* is derived from the next hop parameter [NH]). Finally, keys K_{RRCint}, K_{RRCenc}, K_{UPint} and K_{UPenc} are derived from new K_{gNB}. The RRCReconfiguration complete message transmitted to selected LTM candidate cell is encrypted/integrity protected using K_{RRCenc}/K_{RRCint} keys.

In some embodiments, a next hop chaining counter parameter (NCC) used during failure recovery can be signaled by gNB 604 in the LTM configuration. If this NCC is the same as the NCC associated with the currently active K_{gNB}. UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., K_{gNB} used in source cell]). Otherwise, UE 602 derives a new key K_{gNB} (also referred to as K_{gNB}*) for the target cell (i.e., the selected LTM candidate) cell using vertical key derivation (i.e., K_{gNB}* is derived from the NH). Finally, keys K_{RRCint}, K_{RRCenc}, K_{UPint} and K_{UPenc} are derived from the new K_{gNB}. A RRCReconfiguration complete message transmitted to the selected LTM candidate cell is encrypted/integrity protected using the K_{RRCenc}/K_{RRCint} keys.

In some embodiments, whether to use vertical or horizontal key derivation during failure recovery can be signaled by gNB 604 in the LTM configuration. If horizontal key derivation is indicated UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., K_{gNB} used in source cell]). Otherwise, if vertical key derivation is indicated, UE 602 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. An RRCReconfiguration complete message transmitted to the selected LTM candidate cell is encrypted/integrity protected using the K_{RRCenc}/K_{RRCint} keys.

In some embodiments, at step 665, if attemptLTM-Switch is configured (in the received LTM configuration) and if the selected cell is the candidate LTM Cell (in the received LTM configuration) and if masterKeyUpdate is not received in the LTM configuration of the selected cell:

PDCP COUNT/PDCP_TX_COUNT (and/or other PDCP state variables) for SRB1 are set to the same value(s) at the time of the LTM cell switch procedure failure (e.g., at the time of T 304 expiry), and UE 602 configures the PDCP entity of the SRB1 with state variables continuation (i.e., UE 602 continues with the same value[s] as at the time of the LTM cell switch procedure failure). Alternately, PDCP COUNT/PDCP_TX_COUNT (and/or other PDCP state variables) for SRB3 are set to the same value(s) at the time of the LTM cell switch procedure failure (e.g., at the time of T 304 expiry for the SCG), and UE 602 configures the PDCP entity of the SRB3 with state variables continuation (i.e., UE 602 continues the with same value[s] as at the time of the LTM cell switch procedure failure in the SCG). Alternately, PDCP COUNT/PDCP_TX_COUNT (and/or other PDCP state variables) for SRB(s)/RB(s) are set to the same value(s) at the time of the LTM cell switch procedure failure (e.g., at the time of T 304 expiry), and UE 602 configures the PDCP entities of the SRB(s)/RB(s) with state variables continuation (i.e., UE 602 continues with same value[s] as at the time LTM cell switch procedure failure).

UE 602 performs the LTM cell switch procedure for the selected LTM candidate cell. An RRCReconfiguration complete message is transmitted to the selected LTM candidate cell. PDCP COUNT/PDCP_TX_COUNT equal to N+1 will be used to secure the RRCReconfiguration complete message transmitted to the selected LTM candidate cell.

If the selected cell and cell where cell switch failure occurred belong to a different group (i.e., a different CU or group of cells with a different security key or a group of cells with a different master key update ID or ID, the master key update ID or ID can be signaled per LTM candidate cell, cells belonging to same CU are assigned same value of master key update ID or ID, cells belonging to different CUs are assigned different value of master key update ID or ID):

In some embodiments, UE 602 may derive a new key K_{gNB} (also referred to as K_{gNB}*) for the target cell (i.e., the selected LTM candidate cell) using horizontal key derivation (i.e., K_{gNB}* is derived from the currently active K_{gNB} [i.e., K_{gNB} used in source cell]). Finally, K_{RRCint}, K_{RRCenc}, K_{UPint} and K_{UPenc} are derived from new K_{gNB}. RRCReconfiguration complete message transmitted to selected LTM candidate cell is encrypted/integrity protected using K_{RRCenc}/K_{RRCint} keys.

In some embodiments, UE 602 may derive new key K_{gNB} (also referred as K_{gNB}*) for the target cell (i.e., selected LTM candidate cell) using vertical key derivation (i.e., K_{gNB}* is derived from the next hop parameter [NH]). Finally, keys K_{RRCint}, K_{RRCenc}, K_{UPint} and K_{UPenc} are derived from new K_{gNB}. The RRCReconfiguration complete message transmitted to selected LTM candidate cell is encrypted/integrity protected using K_{RRCenc}/K_{RRCint} keys.

In some embodiments, a next hop chaining counter parameter (NCC) used during failure recovery can be signaled by gNB 604 in the LTM configuration. If this NCC is the same as the NCC associated with the currently active K_{gNB}. UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., K_{gNB} used in source cell]). Otherwise, UE 602 derives a new key K_{gNB} (also referred to as K_{gNB}*) for the target cell (i.e., the selected LTM candidate) cell using vertical key derivation (i.e., K_{gNB}* is derived from the NH). Finally, keys K_{RRCint}, K_{RRCenc}, K_{UPint} and K_{UPenc} are derived from the new K_{gNB}. A RRCReconfiguration complete message transmitted to the selected LTM candidate cell is encrypted/integrity protected using the K_{RRCenc}/K_{RRCint} keys.

In some embodiments, whether to use vertical or horizontal key derivation during failure recovery can be signaled by gNB 604 in the LTM configuration. If horizontal key derivation is indicated UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., K_{gNB} used in source cell]). Otherwise, if vertical key derivation is indicated, UE 602 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. An RRCReconfiguration complete message transmitted to the selected LTM candidate cell is encrypted/integrity protected using the K_{RRCene}/K_{RRCint} keys.

In some embodiments, at step 665, if attemptLTM-Switch is configured (in the received LTM configuration) and if the selected cell is the candidate LTM Cell (in the received LTM configuration) and the security key for this selected cell is the same as the security key to be used for candidate the LTM Cell where the LTM switching failed:

PDCP COUNT/PDCP_TX_COUNT (and/or other PDCP state variables) for SRB1 are set to the same value(s) at the time of the LTM cell switch procedure failure (e.g., at the time of T 304 expiry), and UE 602 configures the PDCP entity of the SRB1 with state variables continuation (i.e., UE 602 continues with the same value[s] as at the time of the LTM cell switch procedure failure). Alternately, PDCP COUNT/PDCP_TX_COUNT (and/or other PDCP state variables) for SRB3 are set to the same value(s) at the time of the LTM cell switch procedure failure (e.g., at the time of T 304 expiry for the SCG), and UE 602 configures the PDCP entity of the SRB3 with state variables continuation (i.e., UE 602 continues the with same value[s] as at the time of the LTM cell switch procedure failure in the SCG). Alternately, PDCP COUNT/PDCP_TX_COUNT (and/or other PDCP state variables) for SRB(s)/RB(s) are set to the same value(s) at the time of the LTM cell switch procedure failure (e.g., at the time of T 304 expiry), and UE 602 configures the PDCP entities of the SRB(s)/RB(s) with state variables continuation (i.e., UE 602 continues with same value[s] as at the time LTM cell switch procedure failure).

UE 602 performs the LTM cell switch procedure for the selected LTM candidate cell. An RRCReconfiguration complete message is transmitted to the selected LTM candidate cell. PDCP COUNT/PDCP_TX_COUNT equal to N+1 will be used to secure the RRCReconfiguration complete message transmitted to the selected LTM candidate cell.

If the selected cell and cell where cell switch failure occurred belong to a different group (i.e., a different CU or group of cells with a different security key or a group of cells with a different master key update ID or ID, the master key update ID or ID can be signaled per LTM candidate cell, cells belonging to same CU are assigned same value of master key update ID or ID, cells belonging to different CUs are assigned different value of master key update ID or ID):

In some embodiments, UE 602 may derive a new key K_{gNB} (also referred to as K_{gNB}*) for the target cell (i.e., the selected LTM candidate cell) using horizontal key derivation (i.e., K_{gNB}* is derived from the currently active K_{gNB} [i.e., K_{gNB} used in source cell]). Finally, K_{RRCint}, K_{RRCenc}, K_{UPint} and K_{UPenc} are derived from new K_{gNB}. RRCReconfiguration complete message transmitted to selected LTM candidate cell is encrypted/integrity protected using K_{RRCenc}/K_{RRCint} keys.

In some embodiments, UE 602 may derive new key K_{gNB} (also referred as K_{gNB}*) for the target cell (i.e., selected LTM candidate cell) using vertical key derivation (i.e., K_{gNB}* is derived from the next hop parameter [NH]). Finally, keys K_{RRCint}, K_{RRCenc}, K_{UPint} and K_{UPenc} are derived from new K_{gNB}. The RRCReconfiguration complete message transmitted to selected LTM candidate cell is encrypted/integrity protected using K_{RRCenc}/K_{RRCint} keys.

In some embodiments, a next hop chaining counter parameter (NCC) used during failure recovery can be signaled by gNB 604 in the LTM configuration. If this NCC is the same as the NCC associated with the currently active K_{gNB}. UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., K_{gNB} used in source cell]). Otherwise, UE 602 derives a new key K_{gNB} (also referred to as K_{gNB}*) for the target cell (i.e., the selected LTM candidate) cell using vertical key derivation (i.e., K_{gNB}* is derived from the NH). Finally, keys K_{RRCint}, K_{RRCenc}, K_{UPint} and K_{UPenc} are derived from the new K_{gNB}. A RRCReconfiguration complete message transmitted to the selected LTM candidate cell is encrypted/integrity protected using the K_{RRCenc}/K_{RRCint} keys.

In some embodiments, whether to use vertical or horizontal key derivation during failure recovery can be signaled by gNB 604 in the LTM configuration. If horizontal key derivation is indicated UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., K_{gNB} used in source cell]). Otherwise, if vertical key derivation is indicated, UE 602 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. An RRCReconfiguration complete message transmitted to the selected LTM candidate cell is encrypted/integrity protected using the K_{RRCenc}/K_{RRCint} keys.

In some embodiments, at step 665, if attemptLIM-Switch is configured (in the received LTM configuration) and if the selected cell is the candidate LTM Cell (in the received LTM configuration) and the security key for this selected cell is the same as the security key to be used for the candidate LTM Cell where the LTM switching failed and this selected cell is not the cell where the LTM switching failed (i.e., the selected cell is a cell other than cell B):

PDCP COUNT/PDCP_TX_COUNT (and/or other PDCP state variables) for SRB1 are set to the same value(s) at the time of the LTM cell switch procedure failure (e.g., at the time of T 304 expiry), and UE 602 configures the PDCP entity of the SRB1 with state variables continuation (i.e., UE 602 continues with the same value[s] as at the time of the LTM cell switch procedure failure). Alternately, PDCP COUNT/PDCP_TX_COUNT (and/or other PDCP state variables) for SRB3 are set to the same value(s) at the time of the LTM cell switch procedure failure (e.g., at the time of T 304 expiry for the SCG), and UE 602 configures the PDCP entity of the SRB3 with state variables continuation (i.e., UE 602 continues the with same value[s] as at the time of the LTM cell switch procedure failure in the SCG). Alternately, PDCP COUNT/PDCP_TX_COUNT (and/or other PDCP state variables) for SRB(s)/RB(s) are set to the same value(s) at the time of the LTM cell switch procedure failure (e.g., at the time of T 304 expiry), and UE 602 configures the PDCP entities of the SRB(s)/RB(s) with state variables continuation (i.e., UE 602 continues with same value[s] as at the time LTM cell switch procedure failure).

UE 602 performs the LTM cell switch procedure for the selected LTM candidate cell. An RRCReconfiguration complete message is transmitted to the selected LTM candidate cell. PDCP COUNT/PDCP_TX_COUNT equal to N+1 will be used to secure the RRCReconfiguration complete message transmitted to the selected LTM candidate cell.

If the selected cell and cell where cell switch failure occurred belong to a different group (i.e., a different CU or group of cells with a different security key or a group of cells with a different master key update ID or ID, the master key update ID or ID can be signaled per LTM candidate cell, cells belonging to same CU are assigned same value of master key update ID or ID, cells belonging to different CUs are assigned different value of master key update ID or ID):

In some embodiments, UE 602 may derive a new key K_{gNB} (also referred to as K_{gNB}*) for the target cell (i.e., the selected LTM candidate cell) using horizontal key derivation (i.e., K_{gNB}* is derived from the currently active K_{gNB} [i.e., K_{gNB} used in source cell]). Finally, K_{RRCint}, K_{RRCenc}, K_{UPint} and K_{UPenc} are derived from new K_{gNB}. RRCReconfiguration complete message transmitted to selected LTM candidate cell is encrypted/integrity protected using K_{RRCenc}/K_{RRCint} keys.

In some embodiments, UE 602 may derive new key K_{gNB} (also referred as K_{gNB}*) for the target cell (i.e., selected LTM candidate cell) using vertical key derivation (i.e., K_{gNB}* is derived from the next hop parameter [NH]). Finally, keys K_{RRCint}, K_{RRCenc}, K_{UPint} and K_{UPenc} are derived from new K_{gNB}. The RRCReconfiguration complete message transmitted to selected LTM candidate cell is encrypted/integrity protected using K_{RRCenc}/K_{RRCint} keys.

In some embodiments, a next hop chaining counter parameter (NCC) used during failure recovery can be signaled by gNB 604 in the LTM configuration. If this NCC is the same as the NCC associated with the currently active K_{gNB}. UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., K_{gNB} used in source cell]). Otherwise, UE 602 derives a new key K_{gNB} (also referred to as K_{gNB}*) for the target cell (i.e., the selected LTM candidate) cell using vertical key derivation (i.e., K_{gNB}* is derived from the NH). Finally, keys K_{RRCint}, K_{RRCenc}, K_{UPint} and K_{UPenc} are derived from the new K_{gNB}. A RRCReconfiguration complete message transmitted to the selected LTM candidate cell is encrypted/integrity protected using the K_{RRCenc}/K_{RRCint} keys.

In some embodiments, whether to use vertical or horizontal key derivation during failure recovery can be signaled by gNB 604 in the LTM configuration. If horizontal key derivation is indicated UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., K_{gNB} used in source cell]). Otherwise, if vertical key derivation is indicated, UE 602 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. An RRCReconfiguration complete message transmitted to the selected LTM candidate cell is encrypted/integrity protected using the K_{RRCenc}/K_{RRCint} keys.

In some embodiments, at step 665, if attemptLIM-Switch is configured (in the received LTM configuration) and if the selected cell is the candidate LTM Cell (in the received LTM configuration) and the selected cell and the cell where the cell switch failure occurred belong to the same group (i.e., the same CU or a group of cells with the same security key or a group of cells with same master key update ID or ID, the master key update ID or ID can be signaled per LTM candidate cell, cells belonging to same CU [or node with PDCP security] are assigned the same value of a master key update ID or ID, cells belonging to a different CU [or node with PDCP security] are assigned different value of a master key update ID or ID):

PDCP COUNT/PDCP_TX_COUNT (and/or other PDCP state variables) for SRB1 are set to the same value(s) at the time of the LTM cell switch procedure failure (e.g., at the time of T 304 expiry), and UE 602 configures the PDCP entity of the SRB1 with state variables continuation (i.e., UE 602 continues with the same value[s] as at the time of the LTM cell switch procedure failure). Alternately, PDCP COUNT/PDCP_TX_COUNT (and/or other PDCP state variables) for SRB3 are set to the same value(s) at the time of the LTM cell switch procedure failure (e.g., at the time of T 304 expiry for the SCG), and UE 602 configures the PDCP entity of the SRB3 with state variables continuation (i.e., UE 602 continues the with same value[s] as at the time of the LTM cell switch procedure failure in the SCG). Alternately, PDCP COUNT/PDCP_TX_COUNT (and/or other PDCP state variables) for SRB(s)/RB(s) are set to the same value(s) at the time of the LTM cell switch procedure failure (e.g., at the time of T 304 expiry), and UE 602 configures the PDCP entities of the SRB(s)/RB(s) with state variables continuation (i.e., UE 602 continues with same value[s] as at the time LTM cell switch procedure failure).

UE 602 performs the LTM cell switch procedure for the selected LTM candidate cell. An RRCReconfiguration complete message is transmitted to the selected LTM candidate cell. PDCP COUNT/PDCP_TX_COUNT equal to N+1 will be used to secure the RRCReconfiguration complete message transmitted to the selected LTM candidate cell.

If the selected cell and cell where cell switch failure occurred belong to a different group (i.e., a different CU or group of cells with a different security key or a group of cells with a different master key update ID or ID, the master key update ID or ID can be signaled per LTM candidate cell, cells belonging to same CU are assigned same value of master key update ID or ID, cells belonging to different CUs are assigned different value of master key update ID or ID):

In some embodiments, UE 602 may derive a new key K_{gNB} (also referred to as K_{gNB}*) for the target cell (i.e., the selected LTM candidate cell) using horizontal key derivation (i.e., K_{gNB}* is derived from the currently active K_{gNB} [i.e., K_{gNB} used in source cell]). Finally, K_{RRCint}, K_{RRCenc}, K_{UPint} and K_{UPenc} are derived from new K_{gNB}. RRCReconfiguration complete message transmitted to selected LTM candidate cell is encrypted/integrity protected using K_{RRCenc}/K_{RRCint} keys.

In some embodiments, UE 602 may derive new key K_{gNB} (also referred as K_{gNB}*) for the target cell (i.e., selected LTM candidate cell) using vertical key derivation (i.e., K_{gNB}* is derived from the next hop parameter [NH]). Finally, keys K_{RRCint}, K_{RRCenc}, K_{UPint} and K_{UPenc} are derived from new K_{gNB}. The RRCReconfiguration complete message transmitted to selected LTM candidate cell is encrypted/integrity protected using K_{RRCenc}/K_{RRCint} keys.

In some embodiments, a next hop chaining counter parameter (NCC) used during failure recovery can be signaled by gNB 604 in the LTM configuration. If this NCC is the same as the NCC associated with the currently active K_{gNB}. UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., K_{gNB} used in source cell]). Otherwise, UE 602 derives a new key K_{gNB} (also referred to as K_{gNB}*) for the target cell (i.e., the selected LTM candidate) cell using vertical key derivation (i.e., K_{gNB}* is derived from the NH). Finally, keys K_{RRCint}, K_{RRCenc}, K_{UPint} and K_{UPenc} are derived from the new K_{gNB}. A RRCReconfiguration complete message transmitted to the selected LTM candidate cell is encrypted/integrity protected using the K_{RRCenc}/K_{RRCint} keys.

In some embodiments, whether to use vertical or horizontal key derivation during failure recovery can be signaled by gNB 604 in the LTM configuration. If horizontal key derivation is indicated UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., K_{gNB} used in source cell]). Otherwise, if vertical key derivation is indicated, UE 602 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. An RRCReconfiguration complete message transmitted to the selected LTM candidate cell is encrypted/integrity protected using the K_{RRCenc}/K_{RRCint} keys.

In some embodiments, at step 665, if attemptLTM-Switch is configured (in the received LTM configuration) and if the selected cell is the candidate LTM Cell (in the received LTM configuration) and the selected cell and the cell where the cell switch failure occurred belong to same group (i.e., the same CU or group of cells with the same security key or group of cells with the same master key update ID or ID, the master key update ID or ID can be signaled per LTM candidate cell, cells belonging to the same CU [or node with PDCP security] are assigned the same value of master key update ID or ID) and this selected cell is not the cell where the LTM switching failed (i.e., the selected cell is other than cell B):

PDCP COUNT/PDCP_TX_COUNT (and/or other PDCP state variables) for SRB1 are set to the same value(s) at the time of the LTM cell switch procedure failure (e.g., at the time of T 304 expiry), and UE 602 configures the PDCP entity of the SRB1 with state variables continuation (i.e., UE 602 continues with the same value[s] as at the time of the LTM cell switch procedure failure). Alternately, PDCP COUNT/PDCP_TX_COUNT (and/or other PDCP state variables) for SRB3 are set to the same value(s) at the time of the LTM cell switch procedure failure (e.g., at the time of T 304 expiry for the SCG), and UE 602 configures the PDCP entity of the SRB3 with state variables continuation (i.e., UE 602 continues the with same value[s] as at the time of the LTM cell switch procedure failure in the SCG). Alternately, PDCP COUNT/PDCP_TX_COUNT (and/or other PDCP state variables) for SRB(s)/RB(s) are set to the same value(s) at the time of the LTM cell switch procedure failure (e.g., at the time of T 304 expiry), and UE 602 configures the PDCP entities of the SRB(s)/RB(s) with state variables continuation (i.e., UE 602 continues with same value[s] as at the time LTM cell switch procedure failure).

UE 602 performs the LTM cell switch procedure for the selected LTM candidate cell. An RRCReconfiguration complete message is transmitted to the selected LTM candidate cell. PDCP COUNT/PDCP_TX_COUNT equal to N+1 will be used to secure the RRCReconfiguration complete message transmitted to the selected LTM candidate cell.

If the selected cell and cell where cell switch failure occurred belong to a different group (i.e., a different CU or group of cells with a different security key or a group of cells with a different master key update ID or ID, the master key update ID or ID can be signaled per LTM candidate cell, cells belonging to same CU are assigned same value of master key update ID or ID, cells belonging to different CUs are assigned different value of master key update ID or ID):

In some embodiments, UE 602 may derive a new key K_{gNB} (also referred to as K_{gNB}*) for the target cell (i.e., the selected LTM candidate cell) using horizontal key derivation (i.e., K_{gNB}* is derived from the currently active K_{gNB} [i.e., K_{gNB} used in source cell]). Finally, K_{RRCint}, K_{RRCenc}, K_{UPint} and K_{UPenc} are derived from new K_{gNB}. RRCReconfiguration complete message transmitted to selected LTM candidate cell is encrypted/integrity protected using K_{RRCenc}/K_{RRCint} keys.

In some embodiments, UE 602 may derive new key K_{gNB} (also referred as K_{gNB}*) for the target cell (i.e., selected LTM candidate cell) using vertical key derivation (i.e., K_{gNB}* is derived from the next hop parameter [NH]). Finally, keys K_{RRCint}, K_{RRCenc}, K_{UPint} and K_{UPenc} are derived from new K_{gNB}. The RRCReconfiguration complete message transmitted to selected LTM candidate cell is encrypted/integrity protected using K_{RRCenc}/K_{RRCint} keys.

In some embodiments, a next hop chaining counter parameter (NCC) used during failure recovery can be signaled by gNB 604 in the LTM configuration. If this NCC is the same as the NCC associated with the currently active K_{gNB}. UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., K_{gNB} used in source cell]). Otherwise, UE 602 derives a new key K_{gNB} (also referred to as K_{gNB}*) for the target cell (i.e., the selected LTM candidate) cell using vertical key derivation (i.e., K_{gNB}* is derived from the NH). Finally, keys K_{RRCint}, K_{RRCenc}, K_{UPint} and K_{UPenc} are derived from the new K_{gNB}. A RRCReconfiguration complete message transmitted to the selected LTM candidate cell is encrypted/integrity protected using the K_{RRCenc}/K_{RRCint} keys.

In some embodiments, whether to use vertical or horizontal key derivation during failure recovery can be signaled by gNB 604 in the LTM configuration. If horizontal key derivation is indicated UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., K_{gNB} used in source cell]). Otherwise, if vertical key derivation is indicated, UE 602 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. An RRCReconfiguration complete message transmitted to the selected LTM candidate cell is encrypted/integrity protected using the K_{RRCenc}/K_{RRCint} keys.

In some embodiments, at step 665, if attemptLTM-Switch is configured (in the received LTM configuration) and if the selected cell is the candidate LTM Cell (in the received LTM configuration) and if masterKeyUpdate is received in the LTM configuration of the selected cell:

UE 602 does not configure the PDCP entities of the SRB1/SRB3/SRB(s)/RB(s) with state variables continuation (i.e., UE 602 does continue with same value(s) as at the time LTM cell switch procedure failure). UE 602 performs the LTM cell switch procedure for the selected LTM candidate cell. PDCP COUNT/PDCP_TX_COUNT equal to N will be used to secure the RRCReconfiguration complete message transmitted to the selected LTM candidate cell.

In some embodiments, UE 602 may derive a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell]). Finally, keys K_{RRCint}, K_{RRCenc}, K_{UPint} and K_{UPenc} are derived from new K_{gNB}. The RRCReconfiguration complete message transmitted to the selected LTM candidate cell is encrypted/integrity protected using the K_{RRCenc}/K_{RRCint} keys.

In some embodiments, UE may 602 derive a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from new K_{gNB}. The RRCReconfiguration complete message transmitted to the selected LTM candidate cell is encrypted/integrity protected using the K_{RRCenc}/K_{RRCint} keys.

In some embodiments, an NCC used during failure recovery can be signaled by gNB 604 in the LTM configuration. If this NCC is the same as the NCC associated with the currently active K_{gNB}. UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell]). Otherwise, UE 602 derives new a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, whether to use vertical or horizontal key derivation during failure recovery can be signaled by gNB 604 in the LTM configuration. If horizontal key derivation is indicated UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell]). Otherwise, if vertical key derivation is indicated, UE 602 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, at step 665, if attemptLTM-Switch is configured (in the received LTM configuration) and if the selected cell is the candidate LTM Cell (in the received LTM configuration) where the LTM switching failed (i.e., the selected cell is cell B):

UE 602 does not configure the PDCP entities of the SRB1/SRB3/SRB(s)/RB(s) with state variables continuation (i.e., UE 602 does continue with same value(s) as at the time LTM cell switch procedure failure). UE 602 performs the LTM cell switch procedure for the selected LTM candidate cell. PDCP COUNT/PDCP_TX_COUNT equal to N will be used to secure the RRCReconfiguration complete message transmitted to the selected LTM candidate cell.

In some embodiments, UE 602 may derive a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell]). Finally, keys K_{RRCint}, K_{RRCenc}, K_{UPint} and K_{UPenc} are derived from new K_{gNB}. The RRCReconfiguration complete message transmitted to the selected LTM candidate cell is encrypted/integrity protected using the K_{RRCenc}/K_{RRCint} keys.

In some embodiments, UE may 602 derive a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from new K_{gNB}. The RRCReconfiguration complete message transmitted to the selected LTM candidate cell is encrypted/integrity protected using the K_{RRCenc}/K_{RRCint} keys.

In some embodiments, an NCC used during failure recovery can be signaled by gNB 604 in the LTM configuration. If this NCC is the same as the NCC associated with the currently active K_{gNB}. UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell]). Otherwise, UE 602 derives new a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, whether to use vertical or horizontal key derivation during failure recovery can be signaled by gNB 604 in the LTM configuration. If horizontal key derivation is indicated UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell]). Otherwise, if vertical key derivation is indicated, UE 602 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, at step 665, if attemptLTM-Switch is configured (in the received LTM configuration) and if the selected cell is the candidate LTM Cell (in the received LTM configuration) and the selected cell and the cell where the cell switch failure occurred belong to a different group (i.e., a different CU or a group of cells with a different security key or a group of cells with a different master key update ID or ID, master key update ID or ID can be signaled per LTM candidate cell, cells belonging to different CU [or node with PDCP security] are assigned a different value of master key update ID or ID):

UE 602 does not configure the PDCP entities of the SRB1/SRB3/SRB(s)/RB(s) with state variables continuation (i.e., UE 602 does continue with same value(s) as at the time LTM cell switch procedure failure). UE 602 performs the LTM cell switch procedure for the selected LTM candidate cell. PDCP COUNT/PDCP_TX_COUNT equal to N will be used to secure the RRCReconfiguration complete message transmitted to the selected LTM candidate cell.

In some embodiments, UE 602 may derive a new key K_{gNB} (also referred to as K_{gNB}*) is derived from the currently active K_{gNB} [i.e., the K_{gNB} used in the source cell]). Finally, keys K_{RRCint}, K_{RRCenc}, K_{UPint} and K_{UPenc} are derived from new K_{gNB}. The RRCReconfiguration complete message transmitted to the selected LTM candidate cell is encrypted/integrity protected using the K_{RRCenc}/K_{RRCint} keys.

In some embodiments, UE may 602 derive a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from new K_{gNB}. The RRCReconfiguration complete message transmitted to the selected LTM candidate cell is encrypted/integrity protected using the K_{RRCenc}/K_{RRCint} keys.

In some embodiments, an NCC used during failure recovery can be signaled by gNB 604 in the LTM configuration. If this NCC is the same as the NCC associated with the currently active K_{gNB}. UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell]). Otherwise, UE 602 derives new a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, whether to use vertical or horizontal key derivation during failure recovery can be signaled by gNB 604 in the LTM configuration. If horizontal key derivation is indicated UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell]). Otherwise, if vertical key derivation is indicated, UE 602 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

Although FIGS. 6A-6B illustrate one example method of fast recovery to an LTM candidate cell upon LTM cell switch failure 600, various changes may be made to FIGS. 6A-6B. For example, while shown as a series of steps, various steps in FIGS. 6A-6B could overlap, occur in parallel, occur in a different order, occur any number of times, be omitted, or replaced by other steps.

In an alternative embodiment of method 600, UE 602 is in Cell A (e.g., the source PCell). At step 630, UE 602 initiates an LTM cell switching procedure to switch to LTM candidate Cell B. UE 602 applies the Cell B configuration received in the LTM configuration (e.g., at step 610). UE 602 starts a supervision timer e.g., T 304. This timer is stopped upon successful switching.

At step 640A, during switching, UE 602 generates an RRCReconfiguration complete message and transmits it to LTM candidate Cell B (e.g., gNB 606). The RRCReconfiguration complete message generated by the RRC layer is secured in the PDCP layer before transmission.

If candidate Cell B belongs to belong to same group (i.e., the same CU or a group of cells with the same security key or a group of cells with the same master key update ID or ID, the master key update ID or ID can be signaled per LTM candidate cell, cells belonging to the same CU [or node with PDCP security] are assigned the same value of master key update ID or ID) as Cell A: the PDCP COUNT (PDCP_TX_COUNT) value for SRB1 in Cell A is N at the time of LTM cell switch initiation (step 635). The PDCP entity for SRB1 is not re-established. This PDCP COUNT (PDCP_TX_COUNT) together with the security key being used in Cell A is used for securing the RRCReconfiguration Complete message transmitted to Cell B. At step 645, the PDCP COUNT (PDCP_TX_COUNT) for SRB 1 is then incremented by 1 and becomes equal to N+1.

If candidate Cell B and Cell A belong to different groups (i.e., different CUs or different groups of cells with a different security key or different group of cells with a different master key update ID or ID, the master key update ID or ID can be signaled per LTM candidate cell, cells belonging to different CU [or node with PDCP security] are assigned a different value of master key update ID or ID): the PDCP entity for SRB1 is re-established. The PDCP COUNT (PDCP_TX_COUNT) is reset to 0. A new security key is derived for use in Cell B. This new PDCP COUNT (PDCP_TX_COUNT) together with the new security key is used for securing the RRCReconfiguration Complete message transmitted to Cell B. At step 645, the PDCP COUNT (PDCP_TX_COUNT) for SRB1 is then incremented by 1 and becomes equal to 1.

The RRCReconfiguration complete message may be transmitted in a PUSCH resource. For example, in some embodiments the PUSCH resource could be Msg3 (i.e., an UL grant received in a RAR if a random access procedure was initiated upon switching initiation). In some embodiments, the PUSCH resource could be MsgA (i.e., if a random access procedure was initiated upon switching initiation). In some embodiments, the PUSCH resource could be a configured grant received in the LTM configuration of candidate cell B for a RACH less cell switch).

If UE 602 has performed a RA procedure upon switching initiation, UE 602 considers that LTM execution is successfully completed when the random access procedure is successfully completed. For RACH-less LTM, UE 602 considers that LTM execution is successfully completed when UE 602 determines that the network has successfully received its first UL data. UE 604 determines successful reception of its first UL data by receiving a PDCCH addressing UE 604's C-RNTI in the target cell, which schedules a new transmission following the first UL data.

The transmission of RRCReconfiguration complete message may fail and T 304 may expire. Expiry of T304 means that LTM switching to LTM candidate cell B is failed.

Upon an LTM cell switch failure (also referred to as a reconfiguration with sync failure) towards the LTM candidate cell of a MCG (or SCG):

At step 655, UE 602 initiates RRC connection re-establishment, starts timer T311, and initiate cell selection.

At step 650, UE 602 selects a cell while T 311 is running.

In some embodiments, at step 665, if attemptLTM-Switch is configured (in the received LTM configuration) and if the selected cell is the candidate LTM Cell (in the received LTM configuration), if the candidate LTM Cell (i.e., Cell B) where the LTM switching failed belongs to the same group (i.e., the same CU or group of cells with the same security key or group of cells with the same master key update ID or ID, the master key update ID or ID can be signaled per LTM candidate cell, cells belonging to same CU [or node with PDCP security] are assigned the same value of master key update ID or ID) as the source PCell (i.e., Cell A), and if the selected candidate LTM Cell (while T311 is running) belongs to the same group (i.e., the same CU or group of cells with same security key or group of cells with same master key update ID or ID, the master key update ID or ID can be signaled per LTM candidate cell, cells belonging to same CU [or node with PDCP security] are assigned same value of master key update ID or ID) as the source PCell (i.e., Cell A), UE 602 reverts back to the UE configuration used in the source PCell except for the PDCP state variables for SRB1, and performs the LTM cell switch procedure for the selected LTM candidate cell. An RRCReconfiguration complete message is transmitted to the selected LTM candidate cell. The security key used in the source PCell (i.e., Cell A) and the current PDCP COUNT/PDCP_TX_COUNT of SRB1 at the time of the failure of the LTM switch to Cell B (i.e., PDCP COUNT/PDCP_TX_COUNT of SRB1 equal to N+1) is used to secure the RRCReconfiguration complete message transmitted to the selected LTM candidate cell.

In some embodiments, at step 665, if attemptLTM-Switch is configured (in the received LTM configuration) and if the selected cell is the candidate LTM Cell (in the received LTM configuration), if the candidate LTM Cell (i.e., Cell B) where the LTM switching failed and the source PCell i.e., Cell A belong to different groups (i.e., different CUs or different groups of cells with a different security key or different groups of cells with a different master key update ID or ID, the master key update ID or ID can be signaled per LTM candidate cell, cells belonging to a different CU [or node with PDCP security] are assigned a different value of master key update ID or ID); and if the selected candidate LTM Cell (while T311 is running) belongs to the same group (i.e., the same CU or a group of cells with the same security key or a group of cells with same master key update ID or ID, master key update ID or ID can be signaled per LTM candidate cell, cells belonging to same CU [or node with PDCP security] are assigned same value of master key update ID or ID) as the source PCell (i.e., Cell A), UE 602 reverts backs to the UE configuration used in the source PCell including the PDCP state variables for SRB1. UE 602 may reset the MAC. UE 602 performs the LTM cell switch procedure for the selected LTM candidate cell. The RRCReconfiguration complete message is transmitted to the selected LTM candidate cell. The security key used in the source PCell (i.e., Cell A) and PDCP COUNT/PDCP_TX_COUNT of SRB1 at the time of initiation of LTM switch to Cell B (i.e., PDCP COUNT/PDCP_TX_COUNT of SRB1 equal to N) is used to secure the RRCReconfiguration complete message transmitted to selected LTM candidate cell.

In some embodiments, at step 665, if attemptLIM-Switch is configured (in the received LTM configuration) and if the selected cell is the candidate LTM Cell (in the received LTM configuration), if the candidate LTM Cell (i.e., Cell B) where the LTM switching failed and the source PCell (i.e., Cell A) belong to different groups (i.e., different CUs or different groups of cells with a different security key or different groups of cells with a different master key update ID or ID, the master key update ID or ID can be signaled per LTM candidate cell, cells belonging to a different CU [or node with PDCP security] are assigned a different value of master key update ID or ID), and if the selected candidate LTM Cell (while T311 is running) belongs to same group (i.e., the same CU or a group of cells with the same security key or a group of cells with same master key update ID or ID, the master key update ID or ID can be signaled per LTM candidate cell, cells belonging to same CU [or node with PDCP security] are assigned same value of master key update ID or ID) as candidate LTM Cell (i.e., Cell B), UE 602 performs the LTM cell switch procedure for the selected LTM candidate cell. The RRCReconfiguration complete message is transmitted to the selected LTM candidate cell. The security key used in the candidate LTM Cell (i.e., Cell B) and the PDCP COUNT/PDCP_TX_COUNT of SRB1 at the time of the failure of the LTM switch to Cell B (i.e., PDCP COUNT/PDCP_TX_COUNT of SRB1 equal to 1) is used to secure the RRCReconfiguration complete message transmitted to the selected LTM candidate cell.

In some embodiments, at step 665, if attemptLIM-Switch is configured (in the received LTM configuration) and if the selected cell is the candidate LTM Cell (in the received LTM configuration), if the selected candidate LTM Cell (while T311 is running) and the candidate LTM Cell of the failed LTM cell switch (i.e., Cell B) belong to different groups (i.e., different CUs or different groups of cells with a different security key or different groups of cells with a different master key update ID or ID, the master key update ID or ID can be signaled per LTM candidate cell, cells belonging to a different CU [or node with PDCP security] are assigned different value of master key update ID or ID), and if the selected cell (while T311 is running) and the source PCell (i.e., Cell A) belong to different groups (i.e., different CUs or different groups of cells with different security key or different groups of cells with a different master key update ID or ID, the master key update ID or ID can be signaled per LTM candidate cell, cells belonging to a different CU [or node with PDCP security] are assigned different value of master key update ID or ID):

In some embodiments, UE 602 may derive a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell]). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, UE 602 may derive a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, an NCC used during failure recovery can be signaled by gNB 604 in the LTM configuration. If this NCC is the same as the NCC associated with the currently active K_{gNB}, UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in source cell]). Otherwise, UE 602 derives a new K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, whether to use vertical or horizontal key derivation during failure recovery can be signaled by gNB 604 in the LTM configuration. If horizontal key derivation is indicated, UE 602 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell]). Otherwise, if vertical key derivation is indicated, UE 602 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

The PDCP entity for SRB1 is re-established. PDCP COUNT (PDCP_TX_COUNT) is reset to 0. This new PDCP COUNT (PDCP_TX_COUNT) together with the new security key is used for securing the RRCReconfiguration Complete message transmitted to the selected candidate cell.

In some embodiments, at step 665, upon LTM cell switch failure, if attemptLIM-Switch is configured, if the target PCell of the failed LTM cell switch and the source PCell belong to different groups (i.e., different CUs or different groups of cells with a different security key or different groups of cells with a different master key update ID or ID, the master key update ID or ID can be signaled per LTM candidate cell, cells belonging to a different CU [or node with PDCP security] are assigned different value of master key update ID or ID), UE 602 reverts back to the UE configuration used in the source PCell. Otherwise, UE 602 reverts back to the UE configuration used in the source PCell except for the PDCP state variables for SRB(s) associated to the MCG.

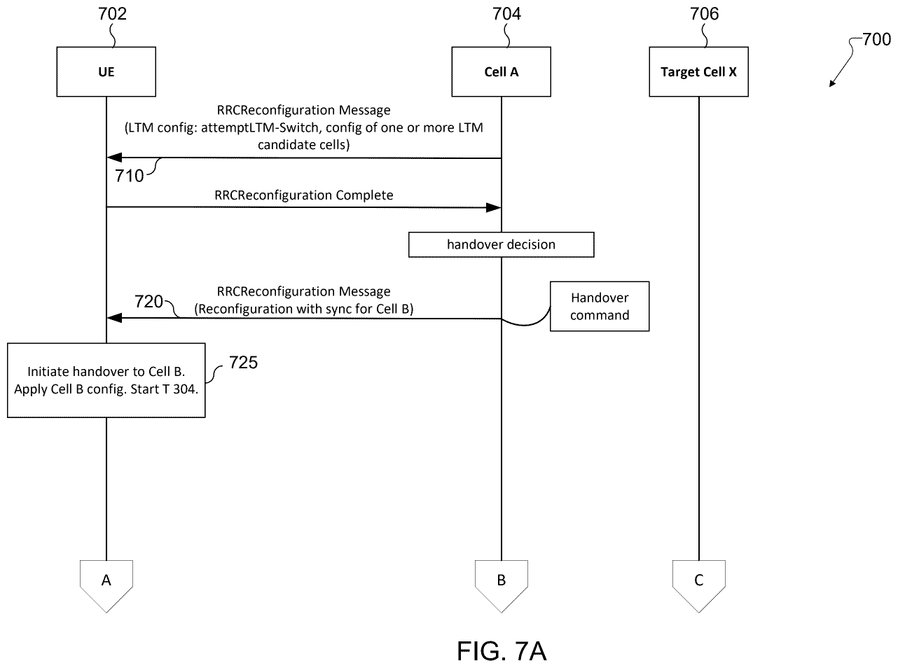

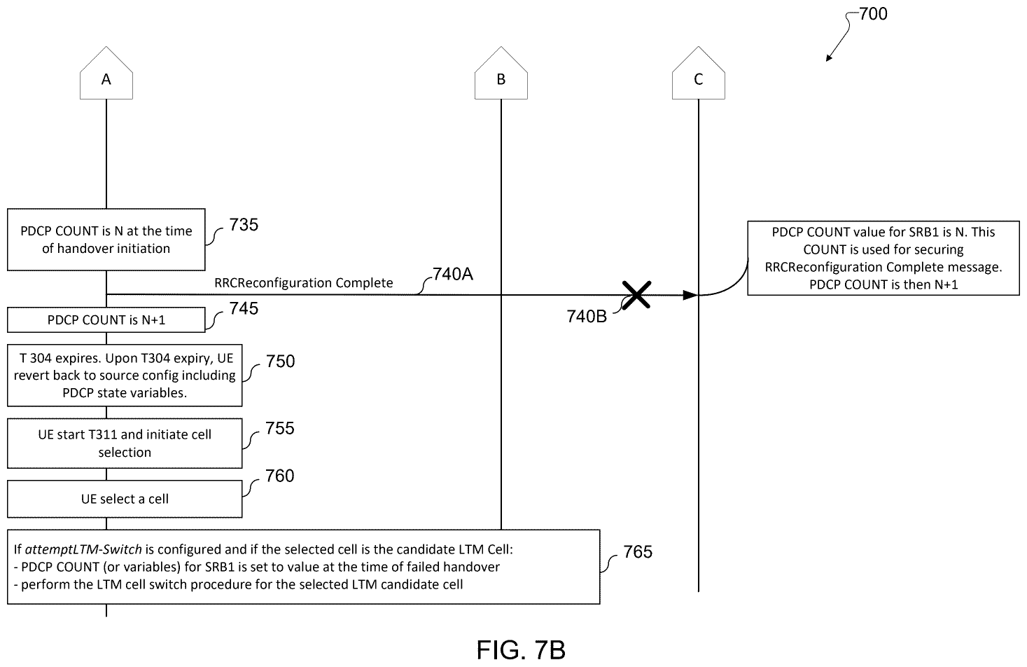

FIGS. 7A-7B illustrate an example method of fast recovery to an LTM candidate cell upon mobility failure 700 according to embodiments of the present disclosure. An embodiment of the method illustrated in FIGS. 7A-7B is for illustration only. One or more of the components illustrated in FIGS. 7A-7B may be implemented in specialized circuitry configured to perform the noted functions or one or more of the components may be implemented by one or more processors executing instructions to perform the noted functions. Other embodiments a method of fast recovery to an LTM candidate cell upon mobility failure could be used without departing from the scope of this disclosure.

In the example of FIGS. 7A-7B, method 700 begins at step 710. At step 710, UE 602 receives an RRCReconfiguration message from gNB 704 of the serving cell (e.g., Cell A) belonging to a MCG. The RRCReconfiguration includes and LTM configuration for the MCG. The LTM configuration may include a configuration of one or more LTM candidate cells (e.g., Cell B, Cell C etc.). The configuration of each LTM candidate cell can be an RRCReconfiguration IE. The LTM configuration may include the parameter attemptLTM-Switch or attemptLTM-Switch set to TRUE. If attemptLTM-Switch is present, the UE executes an LTM cell switch if the selected cell during connection re-establishment is an LTM candidate cell, and the selected cell is the first cell selection after failure.

At step 715, UE 702 sends an RRCReconfiguration complete message in response to the received RRCReconfiguration message.

At step 720, UE 702 may then receive a handover command (i.e., an RRCReconfiguration message with reconfiguration with sync IE) to handover to a target cell (e.g., gNB 706).

At step 725, UE 702 executes a handover procedure to handover to the target cell. UE 702 applies the target cell configuration received in the handover command. UE 702 starts a timer T 304. UE 702 initiates a random access procedure towards the target cell. This timer is stopped upon completion of random access procedure.

At step 740A, UE 702 generates an RRCReconfiguration complete message and transmits it to the target cell. The RRCReconfiguration complete message generated by the RRC layer is secured in the PDCP layer before transmission. The PDCP COUNT (PDCP_TX_COUNT) value for SRB1 is N at the time of handover execution (Step 735). This PDCP COUNT (PDCP TX COUNT) together with a security key is used for securing the RRCReconfiguration Complete message. At step 745, PDCP COUNT (PDCP_TX_COUNT) for SRB1 is then incremented by 1 and it becomes equal to N+1.

The RRCReconfiguration complete message may be transmitted in PUSCH resource. For example, in some embodiments, the PUSCH resource could be a Msg3 (i.e., an UL grant received in a RAR). In some embodiments, the PUSCH resource could be MsgA.

At step 740A, the transmission of RRCReconfiguration complete message may fail (step 740B) and at step 750 T 304 may expire. Expiry of T304 means that handover/reconfiguration with sync is failed.

Upon handover failure:

At step 750, UE 702 reverts back to the source configuration including the PDCP state variables.

At step 755, UE 702 initiates RRC connection re-establishment, starts timer T311, and initiates cell selection.

At step 760 UE 702 selects a cell while T311 is running.

In some embodiments, at step 765, if attemptLTM-Switch is configured (in received LTM configuration) and if the selected cell is the candidate LTM Cell (in received LTM configuration, can be candidate LTM Cell B or any other candidate LTM cell e.g., Cell C):

PDCP COUNT/PDCP_TX_COUNT (and/or other PDCP state variables) for SRB1 are set to the same value(s) at the time of the handover failure (e.g., at the time of T 304 expiry). UE 702 configures the PDCP entity of the SRB1 with state variables continuation (i.e., UE 702 continues with same value[s] as at the time of handover failure). Alternately, PDCP COUNT/PDCP_TX_COUNT (and/or other PDCP state variables) for SRB(s)/RB(s) are set to the same value(s) at the time of the handover failure (e.g., at the time of T 304 expiry). UE 702 configures the PDCP entities of the SRB(s)/RB(s) with state variables continuation (i.e., UE 702 continues with same value[s] as at the of handover failure).

UE 702 performs the LTM cell switch procedure for the selected LTM candidate cell. An RRCReconfiguration complete message is transmitted to the selected LTM candidate cell. PDCP COUNT/PDCP_TX_COUNT equal to N+1 will be used to secure the RRCReconfiguration complete message transmitted to the selected LTM candidate cell.

If the selected cell and the cell where cell switch failure occurred belong to different groups (i.e., different CUs or groups of cells with a different security key or groups of cells with a different master key update ID or ID, the master key update ID or ID can be signaled per LTM candidate cell, cells belonging to the same CU [or node with PDCP security] are assigned the same value of master key update ID or ID, cells belonging to a different CU [or node with PDCP security] are assigned a different value of master key update ID or ID):

In some embodiments, UE 702 may derive a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell]). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments UE 702 may derive a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, an NCC used during failure recovery can be signaled by gNB 704 in the LTM configuration. If this NCC is the same as the NCC associated with the currently active K_{gNB}. UE 702 derives new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in source cell]). Otherwise, UE 702 derives a new K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the elected LTM candidate cell is encrypted/integrity protected using the K_{RRCenc}/K_{RRCint} keys.

In some embodiments, whether to use vertical or horizontal key derivation during failure recovery can be signaled by gNB 604 in the LTM configuration. If horizontal key derivation is indicated UE 702 derives a new key K_{gNB} (also referred as K_{gNB}*) for the target cell (i.e., the selected LTM candidate cell) using horizontal key derivation (i.e., K_{gNB}* is derived from the currently active K_{gNB} [i.e., the K_{gNB} used in source cell]). Otherwise, if vertical key derivation is indicated, UE 702 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, at step 765, if attemptLTM-Switch is configured (in the received LTM configuration) and if the selected cell is the candidate LTM Cell (in the received LTM configuration, which can be candidate LTM Cell B or any other candidate LTM cell e.g., Cell C):

PDCP COUNT/PDCP_TX_COUNT (and/or other PDCP state variables) for SRB1 are set to same value(s) at the time of handover failure (e.g., at the time of T 304 expiry), and UE 702 configures the PDCP entity of the SRB1 with state variables continuation (i.e., UE 702 continues with the same value[s] as at the time of handover failure). Alternately, PDCP COUNT/PDCP_TX_COUNT (and/or other PDCP state variables) for SRB3 are set to the same value(s) at the time of handover failure (e.g., at the time of T 304 expiry for the SCG), and UE 702 configures the PDCP entity of the SRB3 with state variables continuation (i.e., UE 702 continues with the same value[s] as at the time of handover failure in the SCG). Alternately, PDCP

COUNT/PDCP_TX_COUNT (and/or other PDCP state variables) for SRB(s)/RB(s) are set to the same value(s) at the time of the handover failure (e.g., at the time of T 304 expiry), and UE 702 configures the PDCP entities of the SRB(s)/RB(s) with state variables continuation (i.e., UE 702 continues with the same value[s] as at the time of handover failure).

UE 702 performs the LTM cell switch procedure for the selected LTM candidate cell. RRCReconfiguration complete message is transmitted to selected LTM candidate cell. PDCP COUNT/PDCP_TX_COUNT equal to N+1 will be used to secure RRCReconfiguration complete message transmitted to selected LTM candidate cell.

If the selected cell and the cell where the cell switch failure occurred belong to different groups (i.e., different CUs or groups of cells with different security keys or group of cells with a different master key update ID or ID, the master key update ID or ID can be signaled per LTM candidate cell, cells belonging to the same CU are assigned same value of master key update ID or ID, cells belonging to different CUs are assigned different values of a master key update ID or ID):

In some embodiments, UE 702 may derive a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in source cell]). Finally, keys K_{RRCint}, K_{RRCenc}, K_{UPint} and K_{UPenc} are derived from new K_{gNB}. The RRCReconfiguration complete message transmitted to the selected LTM candidate cell is encrypted/integrity protected using the K_{RRCenc}/K_{RRCint} keys.

In some embodiments UE 702 may derive a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, an NCC used during failure recovery can be signaled by gNB 704 in the LTM configuration. If this NCC is the same as the NCC associated with the currently active K_{gNB}. UE 702 derives new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell.}) Otherwise, UE 702 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using K_{RRCenc}/K_{RRCint} keys.

In some embodiments, whether to use vertical or horizontal key derivation during failure recovery can be signaled by gNB 704 in the LTM configuration. If horizontal key derivation is indicated UE 702 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in source cell]). Otherwise, if vertical key derivation is indicated, UE 702 derives a new key K_{gNB} (also referred to as K_{gNB}*) for the target cell (i.e., the selected LTM candidate) cell using vertical key derivation (i.e., K_{gNB}* is derived from the NH). Finally, keys K_{RRCint}, K_{RRCenc}, K_{UPint} and K_{UPenc} are derived from the new K_{gNB}. An RRCReconfiguration complete message transmitted to the selected LTM candidate cell is encrypted/integrity protected using the K_{RRCenc}/K_{RRCint} keys.

In some embodiments, at step 765, if attemptLIM-Switch is configured (in the received LTM configuration) and if the selected cell is the candidate LTM Cell (in the received LTM configuration) and this selected cell is not the cell where the handover failure occurred:

PDCP COUNT/PDCP_TX_COUNT (and/or other PDCP state variables) for SRB1 are set to same value(s) at the time of handover failure (e.g., at the time of T 304 expiry), and UE 702 configures the PDCP entity of the SRB1 with state variables continuation (i.e., UE 702 continues with the same value[s] as at the time of handover failure). Alternately, PDCP COUNT/PDCP_TX_COUNT (and/or other PDCP state variables) for SRB3 are set to the same value(s) at the time of handover failure (e.g., at the time of T 304 expiry for the SCG), and UE 702 configures the PDCP entity of the SRB3 with state variables continuation (i.e., UE 702 continues with the same value[s] as at the time of handover failure in the SCG). Alternately, PDCP COUNT/PDCP_TX_COUNT (and/or other PDCP state variables) for SRB(s)/RB(s) are set to the same value(s) at the time of the handover failure (e.g., at the time of T 304 expiry), and UE 702 configures the PDCP entities of the SRB(s)/RB(s) with state variables continuation (i.e., UE 702 continues with the same value[s] as at the time of handover failure).

UE 702 performs the LTM cell switch procedure for the selected LTM candidate cell. RRCReconfiguration complete message is transmitted to selected LTM candidate cell. PDCP COUNT/PDCP_TX_COUNT equal to N+1 will be used to secure RRCReconfiguration complete message transmitted to selected LTM candidate cell.

If the selected cell and the cell where the cell switch failure occurred belong to different groups (i.e., different CUs or groups of cells with different security keys or group of cells with a different master key update ID or ID, the master key update ID or ID can be signaled per LTM candidate cell, cells belonging to the same CU are assigned same value of master key update ID or ID, cells belonging to different CUs are assigned different values of a master key update ID or ID):

In some embodiments, UE 702 may derive a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in source cell]). Finally, keys K_{RRCint}, K_{RRCenc}, K_{UPint} and K_{UPenc} are derived from new K_{gNB}. The RRCReconfiguration complete message transmitted to the selected LTM candidate cell is encrypted/integrity protected using the K_{RRCenc}/K_{RRCint} keys.

In some embodiments UE 702 may derive a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, an NCC used during failure recovery can be signaled by gNB 704 in the LTM configuration. If this NCC is the same as the NCC associated with the currently active K_{gNB}. UE 702 derives new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell.}) Otherwise, UE 702 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using K_{RRCenc}/K_{RRCint} keys.

In some embodiments, whether to use vertical or horizontal key derivation during failure recovery can be signaled by gNB 704 in the LTM configuration. If horizontal key derivation is indicated UE 702 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in source cell]). Otherwise, if vertical key derivation is indicated, UE 702 derives a new key K_{gNB} (also referred to as K_{gNB}*) for the target cell (i.e., the selected LTM candidate) cell using vertical key derivation (i.e., K_{gNB}* is derived from the NH). Finally, keys K_{RRCint}, K_{RRCenc}, K_{UPint} and K_{UPenc} are derived from the new K_{gNB}. An RRCReconfiguration complete message transmitted to the selected LTM candidate cell is encrypted/integrity protected using the K_{RRCenc}/K_{RRCint} keys.

In some embodiments, at step 765, if attemptLTM-Switch is configured (in the received LTM configuration) and if the selected cell is the candidate LTM Cell (in the received LTM configuration) and if masterKeyUpdate is not received in the LTM configuration of the selected cell:

PDCP COUNT/PDCP_TX_COUNT (and/or other PDCP state variables) for SRB1 are set to same value(s) at the time of handover failure (e.g., at the time of T 304 expiry), and UE 702 configures the PDCP entity of the SRB1 with state variables continuation (i.e., UE 702 continues with the same value[s] as at the time of handover failure). Alternately, PDCP COUNT/PDCP_TX_COUNT (and/or other PDCP state variables) for SRB3 are set to the same value(s) at the time of handover failure (e.g., at the time of T 304 expiry for the SCG), and UE 702 configures the PDCP entity of the SRB3 with state variables continuation (i.e., UE 702 continues with the same value[s] as at the time of handover failure in the SCG). Alternately, PDCP COUNT/PDCP_TX_COUNT (and/or other PDCP state variables) for SRB(s)/RB(s) are set to the same value(s) at the time of the handover failure (e.g., at the time of T 304 expiry), and UE 702 configures the PDCP entities of the SRB(s)/RB(s) with state variables continuation (i.e., UE 702 continues with the same value[s] as at the time of handover failure).

UE 702 performs the LTM cell switch procedure for the selected LTM candidate cell. RRCReconfiguration complete message is transmitted to selected LTM candidate cell. PDCP COUNT/PDCP_TX_COUNT equal to N+1 will be used to secure RRCReconfiguration complete message transmitted to selected LTM candidate cell.

If the selected cell and the cell where the cell switch failure occurred belong to different groups (i.e., different CUs or groups of cells with different security keys or group of cells with a different master key update ID or ID, the master key update ID or ID can be signaled per LTM candidate cell, cells belonging to the same CU are assigned same value of master key update ID or ID, cells belonging to different CUs are assigned different values of a master key update ID or ID):

In some embodiments, UE 702 may derive a new key K_{gNB} (also referred to as K_{gNB}*) is derived from the currently active K_{gNB} [i.e., the K_{gNB} used in source cell]). Finally, keys K_{RRCint}, K_{RRCenc}, K_{UPint} and K_{UPenc} are derived from new K_{gNB}. The RRCReconfiguration complete message transmitted to the selected LTM candidate cell is encrypted/integrity protected using the K_{RRCenc}/K_{RRCint} keys.

In some embodiments UE 702 may derive a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, an NCC used during failure recovery can be signaled by gNB 704 in the LTM configuration. If this NCC is the same as the NCC associated with the currently active K_{gNB}. UE 702 derives new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell.}) Otherwise, UE 702 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using K_{RRCenc}/K_{RRCint} keys.

In some embodiments, whether to use vertical or horizontal key derivation during failure recovery can be signaled by gNB 704 in the LTM configuration. If horizontal key derivation is indicated UE 702 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in source cell]). Otherwise, if vertical key derivation is indicated, UE 702 derives a new key K_{gNB} (also referred to as K_{gNB}*) for the target cell (i.e., the selected LTM candidate) cell using vertical key derivation (i.e., K_{gNB}* is derived from the NH). Finally, keys K_{RRCint}, K_{RRCenc}, K K_{UPint} and K_{UPenc} are derived from the new K_{gNB}. An RRCReconfiguration complete message transmitted to the selected LTM candidate cell is encrypted/integrity protected using the K_{RRCenc}/K_{RRCint} keys.

In some embodiments, at step 765, if attemptLTM-Switch is configured (in the received LTM configuration) and if the selected cell is the candidate LTM Cell (in the received LTM configuration) and the security key for this selected cell is same as the security key of cell where the handover failure occurred:

PDCP COUNT/PDCP_TX_COUNT (and/or other PDCP state variables) for SRB1 are set to same value(s) at the time of handover failure (e.g., at the time of T 304 expiry), and UE 702 configures the PDCP entity of the SRB1 with state variables continuation (i.e., UE 702 continues with the same value[s] as at the time of handover failure). Alternately, PDCP COUNT/PDCP_TX_COUNT (and/or other PDCP state variables) for SRB3 are set to the same value(s) at the time of handover failure (e.g., at the time of T 304 expiry for the SCG), and UE 702 configures the PDCP entity of the SRB3 with state variables continuation (i.e., UE 702 continues with the same value[s] as at the time of handover failure in the SCG). Alternately, PDCP COUNT/PDCP_TX_COUNT (and/or other PDCP state variables) for SRB(s)/RB(s) are set to the same value(s) at the time of the handover failure (e.g., at the time of T 304 expiry), and UE 702 configures the PDCP entities of the SRB(s)/RB(s) with state variables continuation (i.e., UE 702 continues with the same value[s] as at the time of handover failure).

UE 702 performs the LTM cell switch procedure for the selected LTM candidate cell. RRCReconfiguration complete message is transmitted to selected LTM candidate cell. PDCP COUNT/PDCP_TX_COUNT equal to N+1 will be used to secure RRCReconfiguration complete message transmitted to selected LTM candidate cell.

If the selected cell and the cell where the cell switch failure occurred belong to different groups (i.e., different CUs or groups of cells with different security keys or group of cells with a different master key update ID or ID, the master key update ID or ID can be signaled per LTM candidate cell, cells belonging to the same CU are assigned same value of master key update ID or ID, cells belonging to different CUs are assigned different values of a master key update ID or ID):

In some embodiments, UE 702 may derive a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in source cell]). Finally, keys K_{RRCint}, K_{RRCenc}, K_{UPint} and K_{UPenc} are derived from new K_{gNB}. The RRCReconfiguration complete message transmitted to the selected LTM candidate cell is encrypted/integrity protected using the K_{RRCenc}/K_{RRCint} keys.

In some embodiments UE 702 may derive a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, an NCC used during failure recovery can be signaled by gNB 704 in the LTM configuration. If this NCC is the same as the NCC associated with the currently active K_{gNB}. UE 702 derives new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell.}) Otherwise, UE 702 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using K_{RRCenc}/K_{RRCint} keys.

In some embodiments, whether to use vertical or horizontal key derivation during failure recovery can be signaled by gNB 704 in the LTM configuration. If horizontal key derivation is indicated UE 702 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in source cell]). Otherwise, if vertical key derivation is indicated, UE 702 derives a new key K_{gNB} (also referred to as K_{gNB}*) for the target cell (i.e., the selected LTM candidate) cell using vertical key derivation (i.e., K_{gNB}* is derived from the NH). Finally, keys K_{RRCint}, K_{RRCenc}, K_{UPint} and K_{UPenc} are derived from the new K_{gNB}. An RRCReconfiguration complete message transmitted to the selected LTM candidate cell is encrypted/integrity protected using the K_{RRCenc}/K_{RRCint} keys.

In some embodiments, at step 765, if attemptLIM-Switch is configured (in the received LTM configuration) and if the selected cell is the candidate LTM Cell (in the received LTM configuration) and the security key for this selected cell is same as the security key for the Cell where the handover failure occurred, and this selected cell is not the cell where the handover failure occurred:

PDCP COUNT/PDCP_TX_COUNT (and/or other PDCP state variables) for SRB1 are set to same value(s) at the time of handover failure (e.g., at the time of T 304 expiry), and UE 702 configures the PDCP entity of the SRB1 with state variables continuation (i.e., UE 702 continues with the same value[s] as at the time of handover failure). Alternately, PDCP COUNT/PDCP_TX_COUNT (and/or other PDCP state variables) for SRB3 are set to the same value(s) at the time of handover failure (e.g., at the time of T 304 expiry for the SCG), and UE 702 configures the PDCP entity of the SRB3 with state variables continuation (i.e., UE 702 continues with the same value[s] as at the time of handover failure in the SCG). Alternately, PDCP COUNT/PDCP_TX_COUNT (and/or other PDCP state variables) for SRB(s)/RB(s) are set to the same value(s) at the time of the handover failure (e.g., at the time of T 304 expiry), and UE 702 configures the PDCP entities of the SRB(s)/RB(s) with state variables continuation (i.e., UE 702 continues with the same value[s] as at the time of handover failure).

UE 702 performs the LTM cell switch procedure for the selected LTM candidate cell. RRCReconfiguration complete message is transmitted to selected LTM candidate cell. PDCP COUNT/PDCP_TX_COUNT equal to N+1 will be used to secure RRCReconfiguration complete message transmitted to selected LTM candidate cell.

If the selected cell and the cell where the cell switch failure occurred belong to different groups (i.e., different CUs or groups of cells with different security keys or group of cells with a different master key update ID or ID, the master key update ID or ID can be signaled per LTM candidate cell, cells belonging to the same CU are assigned same value of master key update ID or ID, cells belonging to different CUs are assigned different values of a master key update ID or ID):

In some embodiments, UE 702 may derive a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in source cell]). Finally, keys K_{RRCint}, K_{RRCenc}, K_{UPint} and K_{UPenc} are derived from new K_{gNB}. The RRCReconfiguration complete message transmitted to the selected LTM candidate cell is encrypted/integrity protected using the K_{RRCenc}/K_{RRCint} keys.

In some embodiments UE 702 may derive a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, an NCC used during failure recovery can be signaled by gNB 704 in the LTM configuration. If this NCC is the same as the NCC associated with the currently active K_{gNB}. UE 702 derives new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell.}) Otherwise, UE 702 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using K_{RRCenc}/K_{RRCint} keys.

In some embodiments, whether to use vertical or horizontal key derivation during failure recovery can be signaled by gNB 704 in the LTM configuration. If horizontal key derivation is indicated UE 702 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in source cell]). Otherwise, if vertical key derivation is indicated, UE 702 derives a new key K_{gNB} (also referred to as K_{gNB}*) for the target cell (i.e., the selected LTM candidate) cell using vertical key derivation (i.e., K_{gNB}* is derived from the NH). Finally, keys K_{RRCint}, K_{RRCenc}, K_{UPint} and K_{UPenc} are derived from the new K_{gNB}. An RRCReconfiguration complete message transmitted to the selected LTM candidate cell is encrypted/integrity protected using the K_{RRCenc}/K_{RRCint} keys.

In some embodiments, at step 765, if attemptLIM-Switch is configured (in the received LTM configuration) and if the selected cell is the candidate LTM Cell (in the received LTM configuration) and the selected cell and the cell where handover failure occurred belong to the same group (i.e., the same CU or a group of cells with the same security key or a group of cells with same master key update ID or ID, the master key update ID or ID can be signaled per LTM candidate cell, cells belonging to the same CU are assigned same value of master key update ID or ID):

PDCP COUNT/PDCP_TX_COUNT (and/or other PDCP state variables) for SRB1 are set to same value(s) at the time of handover failure (e.g., at the time of T 304 expiry), and UE 702 configures the PDCP entity of the SRB1 with state variables continuation (i.e., UE 702 continues with the same value[s] as at the time of handover failure). Alternately, PDCP COUNT/PDCP_TX_COUNT (and/or other PDCP state variables) for SRB3 are set to the same value(s) at the time of handover failure (e.g., at the time of T 304 expiry for the SCG), and UE 702 configures the PDCP entity of the SRB3 with state variables continuation (i.e., UE 702 continues with the same value[s] as at the time of handover failure in the SCG). Alternately, PDCP COUNT/PDCP_TX_COUNT (and/or other PDCP state variables) for SRB(s)/RB(s) are set to the same value(s) at the time of the handover failure (e.g., at the time of T 304 expiry), and UE 702 configures the PDCP entities of the SRB(s)/RB(s) with state variables continuation (i.e., UE 702 continues with the same value[s] as at the time of handover failure).

UE 702 performs the LTM cell switch procedure for the selected LTM candidate cell. RRCReconfiguration complete message is transmitted to selected LTM candidate cell. PDCP COUNT/PDCP_TX_COUNT equal to N+1 will be used to secure RRCReconfiguration complete message transmitted to selected LTM candidate cell.

If the selected cell and the cell where the cell switch failure occurred belong to different groups (i.e., different CUs or groups of cells with different security keys or group of cells with a different master key update ID or ID, the master key update ID or ID can be signaled per LTM candidate cell, cells belonging to the same CU are assigned same value of master key update ID or ID, cells belonging to different CUs are assigned different values of a master key update ID or ID):

In some embodiments, UE 702 may derive a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in source cell]). Finally, keys K_{RRCint}, K_{RRCenc}, K_{UPint} and K_{UPenc} are derived from new K_{gNB}. The RRCReconfiguration complete message transmitted to the selected LTM candidate cell is encrypted/integrity protected using the K_{RRCenc}/K_{RRCint} keys.

In some embodiments UE 702 may derive a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, an NCC used during failure recovery can be signaled by gNB 704 in the LTM configuration. If this NCC is the same as the NCC associated with the currently active K_{gNB}. UE 702 derives new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell.}) Otherwise, UE 702 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using K_{RRCenc}/K_{RRCint} keys.

In some embodiments, whether to use vertical or horizontal key derivation during failure recovery can be signaled by gNB 704 in the LTM configuration. If horizontal key derivation is indicated UE 702 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in source cell]). Otherwise, if vertical key derivation is indicated, UE 702 derives a new key K_{gNB} (also referred to as K_{gNB}*) for the target cell (i.e., the selected LTM candidate) cell using vertical key derivation (i.e., K_{gNB}* is derived from the NH). Finally, keys K_{RRCint}, K_{RRCenc}, K_{UPint} and K_{UPenc} are derived from the new K_{gNB}. An RRCReconfiguration complete message transmitted to the selected LTM candidate cell is encrypted/integrity protected using the K_{RRCenc}/K_{RRCint} keys.

In some embodiments, at step 765, if attemptLIM-Switch is configured (in the received LTM configuration) and if the selected cell is the candidate LTM Cell (in the received LTM configuration) and the selected cell and the cell where the handover failure occurred belong to the same group (i.e., the same CU or a group of cells with the same security key or a group of cells with same master key update ID or ID, the master key update ID or ID can be signaled per LTM candidate cell, cells belonging to the same CU [or node with PDCP security] are assigned same value of master key update ID or ID) and this selected cell is not the cell where the handover failure occurred:

PDCP COUNT/PDCP_TX_COUNT (and/or other PDCP state variables) for SRB1 are set to same value(s) at the time of handover failure (e.g., at the time of T 304 expiry), and UE 702 configures the PDCP entity of the SRB1 with state variables continuation (i.e., UE 702 continues with the same value[s] as at the time of handover failure). Alternately, PDCP COUNT/PDCP_TX_COUNT (and/or other PDCP state variables) for SRB3 are set to the same value(s) at the time of handover failure (e.g., at the time of T 304 expiry for the SCG), and UE 702 configures the PDCP entity of the SRB3 with state variables continuation (i.e., UE 702 continues with the same value[s] as at the time of handover failure in the SCG). Alternately, PDCP COUNT/PDCP_TX_COUNT (and/or other PDCP state variables) for SRB(s)/RB(s) are set to the same value(s) at the time of the handover failure (e.g., at the time of T 304 expiry), and UE 702 configures the PDCP entities of the SRB(s)/RB(s) with state variables continuation (i.e., UE 702 continues with the same value[s] as at the time of handover failure).

UE 702 performs the LTM cell switch procedure for the selected LTM candidate cell. RRCReconfiguration complete message is transmitted to selected LTM candidate cell. PDCP COUNT/PDCP_TX_COUNT equal to N+1 will be used to secure RRCReconfiguration complete message transmitted to selected LTM candidate cell.

If the selected cell and the cell where the cell switch failure occurred belong to different groups (i.e., different CUs or groups of cells with different security keys or group of cells with a different master key update ID or ID, the master key update ID or ID can be signaled per LTM candidate cell, cells belonging to the same CU are assigned same value of master key update ID or ID, cells belonging to different CUs are assigned different values of a master key update ID or ID):

In some embodiments, UE 702 may derive a new key K_{gNB} (also referred to as K_{gNB}*) is derived from the currently active K_{gNB} [i.e., the K_{gNB} used in source cell]). Finally, keys K_{RRCint}, K_{RRCenc}, K_{UPint} and K_{UPenc} are derived from new K_{gNB}. The RRCReconfiguration complete message transmitted to the selected LTM candidate cell is encrypted/integrity protected using the K_{RRCenc}/K_{RRCint} keys.

In some embodiments UE 702 may derive a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, an NCC used during failure recovery can be signaled by gNB 704 in the LTM configuration. If this NCC is the same as the NCC associated with the currently active K_{gNB}. UE 702 derives new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell.}) Otherwise, UE 702 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using K_{RRCenc}/K_{RRCint} keys.

In some embodiments, whether to use vertical or horizontal key derivation during failure recovery can be signaled by gNB 704 in the LTM configuration. If horizontal key derivation is indicated UE 702 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in source cell]). Otherwise, if vertical key derivation is indicated, UE 702 derives a new key K_{gNB} (also referred to as K_{gNB}*) for the target cell (i.e., the selected LTM candidate) cell using vertical key derivation (i.e., K_{gNB}* is derived from the NH). Finally, keys K_{RRCint}, K_{RRCenc}, K_{UPint} and K_{UPenc} are derived from the new K_{gNB}. An RRCReconfiguration complete message transmitted to the selected LTM candidate cell is encrypted/integrity protected using the K_{RRCenc}/K_{RRCint} keys.

In some embodiments, at step 765, if attemptLTM-Switch is configured (in the received LTM configuration) and if the selected cell is the candidate LTM Cell (in the received LTM configuration) and if masterKeyUpdate is received in the LTM configuration of the selected cell:

UE 702 does not configure the PDCP entities of the SRB1/SRB3/SRB(s)/RB(s) with state variables continuation (i.e., UE 702 does not continue with the same value(s) as at the time LTM cell switch procedure failure).

UE 702 performs the LTM cell switch procedure for the selected LTM candidate cell. PDCP COUNT/PDCP_TX_COUNT equal to N will be used to secure the RRCReconfiguration complete message transmitted to selected LTM candidate cell.

In some embodiments, UE 702 may derive new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, UE 702 may derive a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, an NCC used during failure recovery can be signaled by gNB 704 in the LTM configuration. If this NCC is the same as the NCC associated with the currently active K_{gNB}. UE 702 derives new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell]). Otherwise, UE 702 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, whether to use vertical or horizontal key derivation during failure recovery can be signaled by gNB 704 in the LTM configuration. If horizontal key derivation is indicated. UE 702 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell]). Otherwise, if vertical key derivation is indicated, UE 702 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, at step 765, if attemptLIM-Switch is configured (in the received LTM configuration) and if the selected cell is the candidate LTM Cell (in the received LTM configuration) where the handover failure occurred:

UE 702 does not configure the PDCP entities of the SRB1/SRB3/SRB(s)/RB(s) with state variables continuation (i.e., UE 702 does not continue with the same value(s) as at the time LTM cell switch procedure failure).

UE 702 performs the LTM cell switch procedure for the selected LTM candidate cell. PDCP COUNT/PDCP_TX_COUNT equal to N will be used to secure the RRCReconfiguration complete message transmitted to selected LTM candidate cell.

In some embodiments, UE 702 may derive new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, UE 702 may derive a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, an NCC used during failure recovery can be signaled by gNB 704 in the LTM configuration. If this NCC is the same as the NCC associated with the currently active K_{gNB}. UE 702 derives new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell]). Otherwise, UE 702 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, whether to use vertical or horizontal key derivation during failure recovery can be signaled by gNB 704 in the LTM configuration. If horizontal key derivation is indicated UE 702 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell]). Otherwise, if vertical key derivation is indicated, UE 702 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, at step 765, if attemptLTM-Switch is configured (in the received LTM configuration) and if the selected cell is the candidate LTM Cell (in the received LTM configuration) and the selected cell and the cell where the handover failure occurred belong to different groups (i.e., different CUs or groups of cells with a different security key or groups of cells with a different master key update ID or ID, the master key update ID or ID can be signaled per LTM candidate cell, cells belonging to a different CU [or node with PDCP security are assigned a different value of master key update ID or ID):

UE 702 does not configure the PDCP entities of the SRB1/SRB3/SRB(s)/RB(s) with state variables continuation (i.e., UE 702 does not continue with the same value(s) as at the time LTM cell switch procedure failure).

UE 702 performs the LTM cell switch procedure for the selected LTM candidate cell. PDCP COUNT/PDCP_TX_COUNT equal to N will be used to secure the RRCReconfiguration complete message transmitted to selected LTM candidate cell.

In some embodiments, UE 702 may derive new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, UE 702 may derive a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, an NCC used during failure recovery can be signaled by gNB 704 in the LTM configuration. If this NCC is the same as the NCC associated with the currently active K_{gNB}. UE 702 derives new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell]). Otherwise, UE 702 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, whether to use vertical or horizontal key derivation during failure recovery can be signaled by gNB 704 in the LTM configuration. If horizontal key derivation is indicated. UE 702 derives a new key K_{gNB} (also referred to as K_{gNB}*) for the target cell (i.e., the selected LTM candidate cell) using horizontal key derivation (i.e., K_{gNB}* is derived from the currently active K_{gNB} [i.e., the K_{gNB} used in the source cell]). Otherwise, if vertical key derivation is indicated, UE 702 derives a new key K_{gNB} (also referred to as K_{gNB}*) for the target cell (i.e., the selected LTM candidate cell) using vertical key derivation (i.e., K_{gNB}* is derived from the NH). Finally, keys K_{RRCint}, K_{RRCenc}, K_{UPint} and K_{UPenc} are derived from the new K_{gNB}. The RRCReconfiguration complete message transmitted to the selected LTM candidate cell is encrypted/integrity protected using the K_{RRCenc}/K_{RRCint} keys.

In some embodiments, upon selecting a suitable NR cell, the UE 702 shall:

Ensure having valid and up to date essential system information.

Stop timer T311.

If timer T390 is running, stop timer T390 for all access categories, and perform actions as specified.

Stop the relay (re) selection procedure, if ongoing.

If the cell selection is triggered by detecting radio link failure of the MCG or re-configuration with sync failure of the MCG or mobility from NR failure, and; if attemptCondReconfig is configured; and if the selected cell is not configured with CondEventTI, or the selected cell is configured with CondEventTI and leaving condition has not been fulfilled; and if the selected cell is one of the candidate cells for which the reconfigurationWithSync is included in the masterCellGroup in the MCG VarConditionalReconfig and the condExecutionCondPSCell is not configured for the corresponding condReconfigId in the MCG VarConditionalReconfig: if the UE supports RLF-Report for conditional handover, set the choCellId in the VarRLF-Report to the global cell identity, if available, otherwise to the physical cell identity and carrier frequency of the selected cell; and apply the stored condRRCReconfig associated to the selected cell and perform actions as specified. It is left to network implementation to how to avoid keystream reuse in case of CHO based recovery after a failed handover without key change.

If the cell selection is triggered by detecting radio link failure of the MCG or re-configuration with sync failure of the MCG or mobility from NR failure; and if attemptLTM-Switch is configured; and if the selected cell is one of the LTM candidate cells in the LIM-Candidate IE within VarLTM-Config associated with the MCG: if the cell selection is triggered by re-configuration with sync failure of the MCG or mobility from NR failure; and if the masterKeyUpdate was not received during the re-configuration with sync failure of the MCG or mobility from NR failure, configure the PDCP entity of the SRB 1 (or SRBs or RBs) to continue with state variables as at the time of re-configuration with sync failure or mobility from NR failure; and perform the LTM cell switch procedure for the selected LTM candidate cell.

In some embodiments, at step 765, if attemptLTM-Switch is configured and if the selected cell (during the RRC connection re-establishment i.e., while T311 is running) is the candidate LTM Cell and if the RRC connection re-establishment was triggered due to T304 expiry (legacy handover failure/reconfiguration with sync failure/LTM cell switch failure of MCG [or SCG]) and if the masterKeyUpdate was not received for the failed handover/failed reconfiguration with sync/failed LTM cell switch:

UE 702 configures/instructs the PDCP entity of the SRB 1 (or SRBs or RBs) to continue with state variables as at the time of the T304 expiry (legacy handover failure/reconfiguration with sync failure/LTM cell switch failure).

The RRCReconfiguration complete message is transmitted to the selected LTM candidate cell. PDCP COUNT/PDCP_TX_COUNT value as at the time of the T304 expiry (legacy handover failure/reconfiguration with sync failure/LTM cell switch failure) is used to secure the RRCReconfiguration complete message transmitted to the selected LTM candidate cell.

In some embodiments, at step 765, if attemptLTM-Switch is configured and if the selected cell (during the RRC connection re-establishment i.e., while T311 is running) is the candidate LTM Cell and if the RRC connection re-establishment was triggered due to T304 expiry (legacy handover failure/reconfiguration with sync failure/LTM cell switch failure of MCG [or SCG]) and if the masterKeyUpdate was not received for the failed handover/failed reconfiguration with sync/failed LTM cell switch and the selected cell is different from the cell where the failure occurred:

UE 702 configures/instructs the PDCP entity of the SRB 1 (or SRBs or RBs) to continue with state variables as at the time of the T304 expiry (legacy handover failure/reconfiguration with sync failure/LTM cell switch failure).

The RRCReconfiguration complete message is transmitted to the selected LTM candidate cell. PDCP COUNT/PDCP_TX_COUNT value as at the time of the T304 expiry (legacy handover failure/reconfiguration with sync failure/LTM cell switch failure) is used to secure the RRCReconfiguration complete message transmitted to the selected LTM candidate cell.

In some embodiments, at step 765, if attemptLTM-Switch is configured and if the selected cell (during the RRC connection re-establishment i.e., while T311 is running) is the candidate LTM Cell and if the RRC connection re-establishment was triggered due to T304 expiry (legacy handover failure/reconfiguration with sync failure/LTM cell switch failure of MCG [or SCG]) and if the masterKeyUpdate was received for the failed handover/failed reconfiguration with sync/failed LTM cell switch:

UE 702 does not configure the PDCP entities of the SRB1/SRB3/SRB(s)/RB(s) with state variables continuation (i.e., UE 702 does not continue with same value(s) as at the time LTM cell switch procedure failure).

UE 702 performs the LTM cell switch procedure for the selected LTM candidate cell. PDCP COUNT/PDCP_TX_COUNT equal to N will be used to secure the RRCReconfiguration complete message transmitted to the selected LTM candidate cell.

In some embodiments, at step 765, if attemptLIM-Switch is configured and if the selected cell (during the RRC connection re-establishment i.e., while T311 is running) is the candidate LTM Cell and if the RRC connection re-establishment was triggered due to T304 expiry (legacy handover failure/reconfiguration with sync failure/LTM cell switch failure of MCG [or SCG]) and selected cell is the same as the cell where failure occurred:

UE 702 does not configure the PDCP entities of the SRB1/SRB3/SRB(s)/RB(s) with state variables continuation (i.e., UE 702 does not continue with same value(s) as at the time LTM cell switch procedure failure).

UE 702 performs the LTM cell switch procedure for the selected LTM candidate cell. PDCP COUNT/PDCP_TX_COUNT equal to N will be used to secure the RRCReconfiguration complete message transmitted to the selected LTM candidate cell.

In some embodiments, for the RRC connection re-establishment triggered due to T304 expiry (legacy handover failure/reconfiguration with sync failure/LTM cell switch failure of MCG [or SCG]), whether to continue with PDCP state variables or reset (for SRB 1 and/or SRB3 or RBs) when the selected cell (during the RRC connection re-establishment i.e., while T311 is running) is a candidate LTM cell, can be signaled by gNB 704 in an RRC message (e.g., in the LTM configuration). UE 702 continues PDCP state variables or resets accordingly.

Although FIGS. 7A-7B illustrates one example method of fast recovery to an LTM candidate cell upon mobility failure 700, various changes may be made to FIGS. 7A-7B. For example, while shown as a series of steps, various steps in FIGS. 7A-7B could overlap, occur in parallel, occur in a different order, occur any number of times, be omitted, or replaced by other steps.

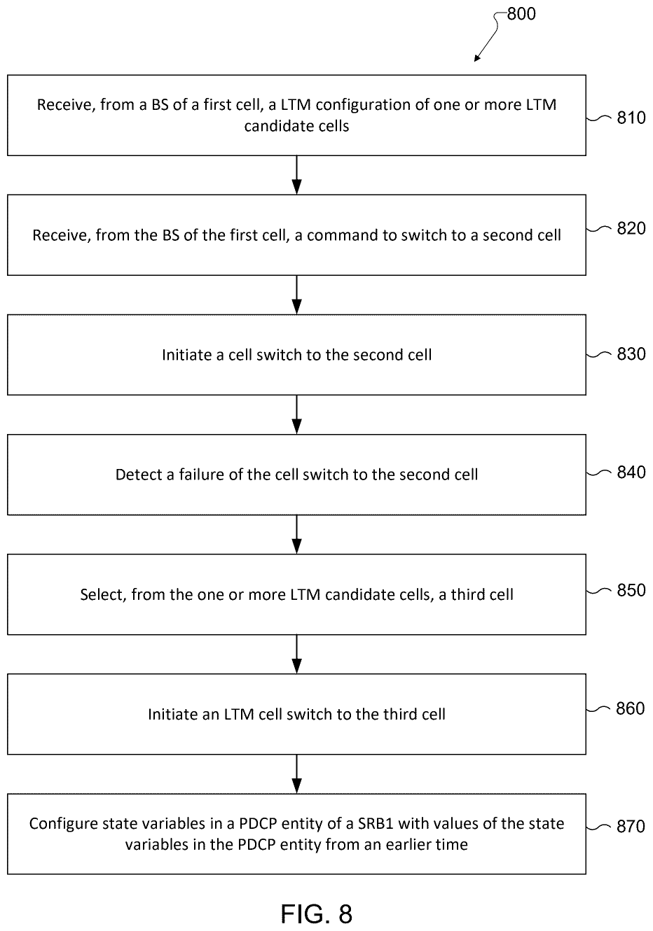

FIG. 8 illustrates an example method for recovering from mobility failure 800 according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a method for recovering from mobility failure could be used without departing from the scope of this disclosure.

In the example of FIG. 8, method 800 begins at step 810. At step 810, a UE (such as UE 116 of FIG. 1) receives, from a BS of a first cell, a LTM configuration of one or more LTM candidate cells.

At step 820, the UE receives, from the BS of the first cell, a command to switch to a second cell.

In some embodiments, the command to switch to the second cell is one of an LTM cell switch command or a RRCReconfiguration message including reconfiguration with sync.

At step 830, the UE initiates a cell switch to the second cell.

At step 840, the UE detects a failure of the cell switch to the second cell.

Upon detection of the failure, at step 850, the UE selects, from the one or more LTM candidate cells, a third cell, and performs a procedure that includes: at step 860, initiating an LTM cell switch to the third cell and, at step 870, configuring state variables in a PDCP entity of a SRB1 with values of the state variables in the PDCP entity from an earlier time.

In some embodiments, the UE determines whether the third cell and the second cell belong to a same group, and in response to a determination that the third cell and the second cell belong to the same group, the UE configures the state variables with the values of the state variables from a time of the detection of the failure. In some embodiments, the UE transmits, to the third cell, an RRCReconfiguration complete message secured by a security key used in the first cell and a PDCP COUNT/PDCP_TX_COUNT of the SRB1 at the time of the detection of the failure.

In some embodiments, the UE determines whether a masterKeyUpdate was received for the failure of the cell switch to the second cell, and in response to a determination that a masterKeyUpdate was not received for the failure of the cell switch to the second cell, the UE configures the state variables with the values of the state variables from a time of the detection of the failure. In some embodiments, the UE transmits, to the third cell, an RRCReconfiguration complete message secured by a security key used in the first cell and a PDCP COUNT/PDCP_TX_COUNT of the SRB1 at the time of the detection of the failure.

In some embodiments, the UE determines whether the first cell and second cell belong to a same group, and determines whether the third cell and first cell belong to the same group. In response to a determination that the first cell and second cell belong to the same group and the third cell and first cell belong to the same group, the UE performs the procedure from step 850, further including reverting a UE configuration to a configuration of a UE configuration used in the first cell, configuring the state variables with the values of the state variables from a time of the detection of the failure, and initiating the LTM cell switch to the third cell. In some embodiments, the UE transmits, to the third cell, an RRCReconfiguration complete message secured by a security key used in the first cell and a PDCP COUNT/PDCP_TX_COUNT of the SRB1 at the time of the detection of the failure.

In some embodiments, the UE determines whether the first cell and second cell belong to a same group, and determines whether the third cell and first cell belong to the same group. In response to a determination that the first cell and second cell belong to a different group and the third cell and first cell belong to the same group, the UE performs the procedure from step 850, further including reverting a UE configuration to a configuration of a UE configuration used in the first cell, configuring the state variables with the values of the state variables at the time of initiation of the cell switch to the second cell, and initiating the LTM cell switch to the third cell. In some embodiments, the UE transmits, to the third cell, an RRCReconfiguration complete message secured by a security key used in the first cell and a PDCP COUNT/PDCP_TX_COUNT of the SRB1 at the time of initiation of the cell switch to the second cell.

In some embodiments, UE determines whether the first cell and second cell belong to a same group, and determines whether the third cell and second cell belong to the same group. In response to a determination that the first cell and second cell belong to a different group and the third cell and second cell belong to the same group, the UE performs the procedure from step 850, further including configuring the state variables with the values of the state variables at the time of the detection of the failure, and initiating the LTM cell switch to the third cell. In some embodiments, the UE transmits, to the third cell, an RRCReconfiguration complete message secured by a security key used in the second cell and a PDCP COUNT/PDCP_TX_COUNT of the SRB1 at the time of the detection of the failure.

Although FIG. 8 illustrates one example method for recovering from mobility failure 800, various changes may be made to FIG. 8. For example, while shown as a series of steps, various steps in FIG. 8 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to:
receive, from a base station (BS) of a first cell, a lower layer triggered mobility (LTM) configuration of one or more LTM candidate cells; and
receive, from the BS of the first cell, a command to switch to a second cell; and
a processor operatively coupled to the transceiver, the processor configured to:
initiate a cell switch to the second cell;
detect a failure of the cell switch to the second cell; and
upon detection of the failure:
select, from the one or more LTM candidate cells, a third cell; and
perform a procedure including:
initiating an LTM cell switch to the third cell; and
configuring state variables in a packet data convergence protocol (PDCP) entity of a signaling radio bearer 1 (SRB1) with values of the state variables in the PDCP entity from an earlier time.

2. The UE of claim 1, wherein the command to switch to the second cell is one of an LTM cell switch command or a RRCReconfiguration message including reconfiguration with sync.

3. The UE of claim 1, wherein the processor is further configured to:
determine whether the third cell and the second cell belong to a same group; and
in response to a determination that the third cell and the second cell belong to the same group, configure the state variables with the values of the state variables from a time of the detection of the failure.

4. The UE of claim 3, wherein the processor is further configured to transmit, to the third cell, an RRCReconfiguration complete message secured by a security key used in the first cell and a PDCP COUNT/PDCP_TX_COUNT of the SRB1 at the time of the detection of the failure.

5. The UE of claim 1, wherein the processor is further configured to:
determine whether a masterKeyUpdate was received for the failure of the cell switch to the second cell; and
in response to a determination that a masterKeyUpdate was not received for the failure of the cell switch to the second cell, configure the state variables with the values of the state variables from a time of the detection of the failure.

6. The UE of claim 5, wherein the processor is further configured to transmit, to the third cell, an RRCReconfiguration complete message secured by a security key used in the first cell and a PDCP COUNT/PDCP_TX_COUNT of the SRB1 at the time of the detection of the failure.

7. The UE of claim 1, wherein the processor is further configured to:
determine whether the first cell and second cell belong to a same group;
determine whether the third cell and first cell belong to the same group; and
in response to a determination that the first cell and second cell belong to the same group and the third cell and first cell belong to the same group, perform the procedure wherein the procedure further includes:
reverting a UE configuration to a configuration of a UE configuration used in the first cell;
configuring the state variables with the values of the state variables from a time of the detection of the failure; and
initiating the LTM cell switch to the third cell.

8. The UE of claim 7, wherein the processor is further configured to transmit, to the third cell, an RRCReconfiguration complete message secured by a security key used in the first cell and a PDCP COUNT/PDCP_TX_COUNT of the SRB1 at the time of the detection of the failure.

9. The UE of claim 1, wherein the processor is further configured to:
determine whether the first cell and second cell belong to a same group;
determine whether the third cell and first cell belong to the same group; and
in response to a determination that the first cell and second cell belong to a different group and the third cell and first cell belong to the same group, perform the procedure wherein the procedure further includes:
reverting a UE configuration to a configuration of a UE configuration used in the first cell;
configuring the state variables with the values of the state variables at the time of initiation of the cell switch to the second cell; and
initiating the LTM cell switch to the third cell.

10. The UE of claim 9, wherein the processor is further configured to transmit, to the third cell, an RRCReconfiguration complete message secured by a security key used in the first cell and a PDCP COUNT/PDCP_TX_COUNT of the SRB1 at the time of initiation of the cell switch to the second cell.

11. The UE of claim 1, wherein the processor is further configured to:
determine whether the first cell and second cell belong to a same group;
determine whether the third cell and second cell belong to the same group; and
in response to a determination that the first cell and second cell belong to a different group and the third cell and second cell belong to the same group, perform the procedure wherein the procedure further includes:
configuring the state variables with the values of the state variables at the time of the detection of the failure; and
initiating the LTM cell switch to the third cell.

12. The UE of claim 11, wherein the processor is further configured to transmit, to the third cell, an RRCReconfiguration complete message secured by a security key used in the second cell and a PDCP COUNT/PDCP_TX_COUNT of the SRB1 at the time of the detection of the failure.

13. The UE of claim 3, wherein the cells belong to the same group if the cells belong to a same centralized unit (CU) or the cells have a same master key update ID or same security keys are used in the cells.

14. A method of operating a user equipment (UE), the method comprising:
receiving, from a base station (BS) of a first cell, a lower layer triggered mobility (LTM) configuration of one or more LTM candidate cells;
receiving, from the BS of the first cell, a command to switch to a second cell;
initiating a cell switch to the second cell;
detecting a failure of the cell switch to the second cell; and
upon detection of the failure:
selecting, from the one or more LTM candidate cells, a third cell; and
performing a procedure including:
initiating an LTM cell switch to the third cell; and
configuring state variables in a packet data convergence protocol (PDCP) entity of a signaling radio bearer 1 (SRB1) with values of the state variables in the PDCP entity from an earlier time.

15. The method of claim 14, wherein the command to switch to the second cell is one of an LTM cell switch command or a RRCReconfiguration message including reconfiguration with sync.

16. The method of claim 14, further comprising:
determining whether the third cell and the second cell belong to a same group; and
in response to a determination that the third cell and the second cell belong to the same group, configuring the state variables with the values of the state variables from a time of the detection of the failure.

17. The method of claim 16, further comprising transmitting, to the third cell, an RRCReconfiguration complete message secured by a security key used in the first cell and a PDCP COUNT/PDCP_TX_COUNT of the SRB1 at the time of the detection of the failure.

18. The method of claim 14, further comprising:
determining whether a masterKeyUpdate was received for the failure of the cell switch to the second cell; and
in response to a determination that a masterKeyUpdate was not received for the failure of the cell switch to the second cell, configuring the state variables with the values of the state variables from a time of the detection of the failure.

19. The method of claim 18, further comprising transmitting, to the third cell, an RRCReconfiguration complete message secured by a security key used in the first cell and a PDCP COUNT/PDCP_TX_COUNT of the SRB1 at the time of the detection of the failure.

20. The method of claim 14, further comprising:
determining whether the first cell and second cell belong to a same group;
determining whether the third cell and first cell belong to the same group; and
in response to a determination that the first cell and second cell belong to the same group and the third cell and first cell belong to the same group, performing the procedure, wherein the procedure further includes:
reverting a UE configuration to a configuration of a UE configuration used in the first cell;
configuring the state variables with the values of the state variables from a time of the detection of the failure; and
initiating the LTM cell switch to the third cell.

21. The method of claim 20, further comprising transmitting, to the third cell, an RRCReconfiguration complete message secured by a security key used in the first cell and a PDCP COUNT/PDCP_TX_COUNT of the SRB1 at the time of the detection of the failure.

22. The method of claim 14, further comprising:
determining whether the first cell and second cell belong to a same group;
determining whether the third cell and first cell belong to the same group; and
in response to a determination that the first cell and second cell belong to a different group and the third cell and first cell belong to the same group, performing the procedure, wherein the procedure further includes:
reverting a UE configuration to a configuration of a UE configuration used in the first cell;
configuring the state variables with the values of the state variables at the time of initiation of the cell switch to the second cell; and
initiating the LTM cell switch to the third cell.

23. The method of claim 22, further comprising transmitting, to the third cell, an RRCReconfiguration complete message secured by a security key used in the first cell and a PDCP COUNT/PDCP_TX_COUNT of the SRB1 at the time of initiation of the cell switch to the second cell.

24. The method of claim 14, further comprising:
determining whether the first cell and second cell belong to a same group;
determining whether the third cell and second cell belong to the same group; and
in response to a determination that the first cell and second cell belong to a different group and the third cell and second cell belong to the same group, performing the procedure, wherein the procedure further includes:
configuring the state variables with the values of the state variables at the time of the detection of the failure; and
initiating the LTM cell switch to the third cell.

25. The method of claim 24, further comprising transmitting, to the third cell, an RRCReconfiguration complete message secured by a security key used in the second cell and a PDCP COUNT/PDCP_TX_COUNT of the SRB1 at the time of the detection of the failure.
